(19) United States
(12) Patent Application Publication
(10) Pub. No.: US 2013/0244159 A1
(43) Pub. Date: Sep. 19, 2013

(54) TWO-COMPONENT DEVELOPER

(71) Applicants: Koh Ishigami, Abiko-shi (JP); Nozomu Komatsu, Toride-shi (JP); Kentaro Kamae, Kashiwa-shi (JP); Yoshinobu Baba, Yokohama-shi (JP)

(72) Inventors: Koh Ishigami, Abiko-shi (JP); Nozomu Komatsu, Toride-shi (JP); Kentaro Kamae, Kashiwa-shi (JP); Yoshinobu Baba, Yokohama-shi (JP)

(73) Assignee: CANON KABUSHIKI KAISHA, Tokyo (JP)

(21) Appl. No.: 13/988,867

(22) PCT Filed: Nov. 24, 2011
(86) PCT No.: PCT/JP2011/077741

§ 371 Date: May 22, 2013

(30) Foreign Application Priority Data
Nov. 30, 2010 (JP) 2010-266546

(51) Int. Cl. G03G 9/083

(52) U.S. Cl. CPC G03G 9/0832
USPC 430/106.2

(57) ABSTRACT

Provided is a two-component developer having excellent developing performance and little change in image concentration, and achieving long-term suppression of image defects such as transfer failure and fogging.

Provided is a two-component developer containing a magnetic carrier and a toner, wherein the magnetic carrier has magnetic carrier particles comprising a silicone resin B coated on the surfaces of filled core particles in which pores of porous magnetic core particles are filled with a silicone resin A, the silicone resin A is a silicone resin cured in the presence of a non-metal catalyst or without a catalyst, while the silicone resin B is a silicone resin cured in the presence of a metal catalyst having titanium or zirconium, and the toner contains a binder resin, a release agent and a colorant, and has an average circularity of 0.940 or more.

### TECHNICAL FIELD

The present invention relates to a two-component developer having a magnetic carrier and a toner, for use in electrophotographic and electrostatic recording methods.

### BACKGROUND ART

Electrophotographic developing systems include one-component development systems using only toner and two-component systems using a mixture of a toner and a magnetic carrier. Two-component development systems use two-component developers obtained by mixing a toner with a magnetic carrier, which is the charge-providing member of the system. Currently, most magnetic carriers are resin-coated carriers comprising ferrite or other magnetic core particles coated on the surface with resin, and in some cases conductive particles, charge-control agents or the like are added to the surface coat layer with the aim of controlling the charge-providing function or resistance.

There have been many proposals for carriers using silicone resin as the coating resin of a resin-coated carrier. It has also been proposed that the silicone resin of the coat layer in a silicone resin-coated carrier be cured with a specific titanium catalyst (see for example Patent Document 1). According to this document, improved dispersibility of the conductive particles in the silicone resin coat layer, uniform distribution of the triboelectric charge quantity and good long-term image characteristics are achieved by selecting a specific titanium catalyst. Also according to this document, this carrier is obtained by coating 1 mass % of silicone resin on ferrite cores with a particle diameter of 80 μm in a fluidized bed, and the surface of the carrier has a thick, smooth coat layer with few bumps and indentations. If this is combined with a toner with a high degree of circularity, the toner and magnetic carrier contact each other at points, and the rise-up of charging is slower due to the lower contact frequency. When images with a high image ratio are output continuously in high-temperature, high-humidity environments in particular, the toner supplied inside the developing device is transported to the developing site without acquiring sufficient charge because the rise in triboelectric charge is too slow. This can cause fogging during large-volume replenishment due to the flight of counter-charged or weakly-charged toner to white areas where the toner is not supposed to go.

Similarly, a silicone resin-coated carrier has been proposed comprising a silicone resin coat layer formed from a specific coupling agent, an organic metal compound catalyst, a specific chloride and a negative charge control agent (see for example Patent Document 2). In this technology, the aim is to control charge, increase film strength and maintain the charge-providing function even when the coat layer becomes worn, rather than to control the surface properties of the carrier. Consequently, the contact frequency and adhesion between the toner and carrier are not controlled, and the carrier surface does not effectively form sites for the decay of counter-charge generated on the carrier surface after toner development. Developing performance may thus be adversely affected. Also, because this technique uses ferrite with a high specific gravity, the toner inside the developing device is subjected to great stress from the magnetic carrier. Thus, external additives on the toner surface are pushed towards the toner particles by contact with the magnetic carrier. The non-static adhesive force of the toner is thus increased especially when the toner contains a release agent. The toner then adheres strongly to the photosensitive member or intermediate transfer member and is not transferred properly, resulting in image defects caused by faulty transfer. Faulty transfer is a particular problem when forming images by superimposing multiple colors on recording paper with a low degree of surface smoothness, and color irregularities may occur because certain colors of toner are not transferred and do not mix with other colors.

In order to reduce stress on the toner, a resin-filled ferrite carrier has been proposed in which porous magnetic core particles with pores in the core are filled with a silicone resin, and then further coated with a silicone resin (see for example Patent Document 3). A magnetic carrier manufacturing method has also been proposed wherein the maximum theoretic filling amount is calculated from the density of a resin and the internal pore volume of a porous magnetic core material, which is then filled in accordance with the maximum theoretical filling amount (Patent Document 4). A low specific gravity of the carrier is achieved with this technique, and there is no charge interference from floating resin. However, since the filled state of the resin and the surface state of the magnetic carrier after coating are not controlled, the resin coat layer is formed with a uniform thickness over the bumps and indentations of the core, leaving few low-resistance sites on the carrier surface, so that the counter-charge generated on the carrier surface after toner development cannot be made to decay, and counter-charge remains on the carrier surface. Thus, toner that has been developed onto the photosensitive member may be pulled back by the counter-charge of the carrier, resulting in insufficient development. For these reasons, no magnetic carrier has been obtained in which the triboelectric charge-providing part and charge-decay part of the magnetic carrier surface are controlled.
[Patent Document 1] Japanese Patent Application Laid-open No. 2001-092189
[Patent Document 2] Japanese Patent Application Laid-open No. 2009-276532
[Patent Document 3] Japanese Patent Application Laid-open No. 2006-337579
[Patent Document 4] Japanese Patent Application Laid-open No. 2009-086093

### DISCLOSURE OF THE INVENTION

As discussed above, methods have been studied for improving the stability and stress resistance of two-component developers. However, no two-component developer has been obtained that satisfies the requirement of long-term stability and yields high-quality images free of image defects over a long period of time using a magnetic carrier comprising a silicone resin coated on filled core particles obtained by filling porous magnetic core particles with a silicone resin.

It is an object of the present invention to provide a two-component developer that resolves these problems. It is also an object of the present invention to provide a two-component developer that yields high-quality images over a long period of time, with good developing performance, little change in image concentration, and long-term suppression of image defects such as transfer failure and fogging.

The present invention relates to a two-component developer containing a magnetic carrier and a toner, wherein the magnetic carrier has magnetic carrier particles which are filled core particles whose surfaces are coated with a silicone resin B, wherein the filled core particles are porous magnetic core particles whose pores are filled with a silicone resin A, wherein the silicone resin A is a silicone resin cured in the presence of a non-metal catalyst or without a catalyst, while the silicone resin B is a silicone resin cured in the presence of a metal catalyst having titanium or zirconium, and wherein the toner contains a binder resin, a release agent and a colorant, and has an average circularity of 0.940 or more.

As explained above, with the present invention it is possible to obtain high-quality images over a long period of time, with good developing performance, little change in image concentration, and long-term suppression of image defects such as transfer failure and fogging.

### BRIEF DESCRIPTION OF DRAWINGS

FIG. 1 is a model view of a toner surface modification device.

FIG. 2 shows the pore diameter distribution of porous magnetic core particles as measured by the mercury intrusion method.

FIG. 3 is an enlarged view showing the pore diameter distribution of porous magnetic core particles as measured by the mercury intrusion method.

### MODE FOR CARRYING OUT THE INVENTION

The magnetic carrier used in the present invention has magnetic carrier particles which are filled core particles whose surfaces are coated with a silicone resin B, and the filled core particles are porous magnetic core particles whose pores are filled with a silicone resin A. Silicone resin A is a silicone resin that has been cured either in the presence of a non-metal catalyst or without a catalyst, and silicone resin B is a silicone resin that has been cured in the presence of a metal catalyst having titanium or zirconium.

The toner used in the present invention contains a binder resin, a release agent and a colorant, and the average circularity of the toner is 0.940 or more.

It is thought that by using such a magnetic carrier and toner as a two-component developer, it is possible to achieve a developer with superior charge rising performance, whereby the counter-charge generated on the surfaces of the magnetic carrier particles can be made to decay rapidly. The rise in triboelectric charge is an indictor of how easy it is to triboelectrically charge the developer. If a developer has good charge rising performance, the desired triboelectric charge quantity can be achieved even if the developer is agitated weakly or for a short period of time. In the case of image formation using replenishing developer, uncharged toner supplied to the developing device can quickly be provided with triboelectric charge up to the saturation triboelectric charge quantity. It is thus possible to control image defects due to insufficient toner charge.

The magnetic carrier particles used in the present invention have on their surfaces indentations derived from pores in the porous magnetic core particles and bumps derived from the porous magnetic core particles. The surface profile with irregularities makes the two-component developer of the present invention highly fluid. This increases the contact frequency between the toner and the resin on the bumps, giving the developer superior charge rising performance.

Because of this, images with high image ratios can be output continuously, and fogging can be controlled because charge is provided rapidly even when uncharged toner continues to be replenished intermittently and in large quantities. The inventors believe that the reasons for this are as follows.

It is thought that the contact area between the toner and the magnetic carrier must be increased in order to improve the charge rising performance. During development, moreover, the counter-charge on the surfaces of the magnetic carrier particles must be mitigated after the toner has left the magnetic carrier.

The silicone resin A used in the present invention is one that is cured either in the presence of a non-metal catalyst or without a catalyst. It is thus possible to control how the resin fills the porous magnetic core particles, and to obtain filled core particles having surface bumps and indentations deriving from the shape of the porous magnetic core particles.

The surfaces of such filled core particles are coated with the silicone resin B cured in the presence of a metal catalyst having titanium or zirconium, thereby producing a smooth coat layer on the surfaces of the magnetic carrier particles. This produces a magnetic carrier with good fluidity. The surfaces of the magnetic carrier particles have bumps and indentations derived from the porous magnetic core particles. The inventors theorize that the contact area between the toner and magnetic carrier particles is increased due to the indentations on the magnetic carrier particle surfaces, resulting in a developer with improved triboelectric charge rising performance. Thus, images with high image ratios can be output continuously, charge is provided rapidly up to the saturation triboelectric charge quantity of the developer, and fogging can be controlled even when the developer is replenished in large quantities.

Once the toner has been developed, counter-charge occurs on the surfaces of the magnetic carrier particles. Because the counter-charge generated on the carrier surfaces acts to pull back the toner, it must be made to decay rapidly in order to improve developing performance.

The magnetic carrier used in the present invention provides excellent developing performance because the counter-charge generated on the surfaces of the core particles can be made to decay rapidly via low-resistance areas where the core particles are thinly coated with resin. The inventors believe that the reasons for this are as follows.

Looking at the surface condition of the magnetic carrier, it is believed that by selecting the catalyst used during resin coating of the filled core particles, it was possible to give a thickness distribution to the resin on the surface of the magnetic carrier particles. Areas of low resistance were formed on parts of the magnetic carrier particle surfaces, allowing the counter-charge generated on the magnetic carrier particle surfaces after toner development to decay rapidly towards the developer carrier, resulting in high developing performance.

Currently the counter-charge generated on the magnetic carrier particle surfaces is made to decay via magnetic chains formed on the developer carrier, and these magnetic chains require conductive pathways. In the magnetic carrier used in the present invention, the porous magnetic core particles are filled with the silicone resin A, which is cured either in the presence of a non-metal catalyst or without a catalyst. This optimizes the wetting speed between the porous magnetic core particles and the resin solution and the resin curing speed, so that the filled core particles can be filled without any remaining air (gaps). As a result, the counter-charge generated on the magnetic carrier particle surfaces after toner development decays rapidly, increasing the developing performance of the developer. When insulating air is present inside the magnetic carrier particles, it is difficult for the counter-charge to decay rapidly. This detracts from the developing performance of the developer.

In general, the drying time is shorter and the resin is harder if a silicone resin solution is cured in the presence of a metal catalyst rather than with a non-metal catalyst or without a catalyst. Thus, when resin solution filling porous magnetic core particles is cured in the presence of a metal catalyst, it is more difficult to form indentations derived from pores in the porous magnetic core particles. This is because curing proceeds rapidly, so that the silicone resin solution immediately loses its flexibility and fluidity, and the resin does not penetrate into the interior of the porous magnetic cores.

The coat layer of resin B, which is cured in the presence of a metal catalyst having titanium or zirconium, has a smooth hard surface, making it difficult for external additives to be spent on the magnetic carrier particle surfaces, and providing improved abrasion resistance. Because the resin can be cured quickly when a resin solution is cured in the presence of a metal catalyst having titanium or zirconium, few unified particles are produced during the resin coating process. If the coat layer on the surface of the magnetic carrier particles is smooth, external toner additives are unlikely to be spent on the surfaces of the magnetic carrier particles, and fluctuations in the charge-providing function are controlled. As a result, there is less change in image quality and concentration even during long-term use, and stable image output is possible. Even during long-term use, moreover, the coat layer has better abrasion resistance, and there is less shaving of the coat layer, less change in the charge-providing function, and less fluctuation in image quality and concentration.

The image concentration may fluctuate or image quality may decline if the resin is cured with a catalyst other than a metal catalyst having titanium or zirconium. The time taken to cure and dry the resin is longer with such a catalyst than with a titanium catalyst, and unified particles are more likely to be generated during the resin coating process. Cracking of the unified particles generated during the resin coating process produces fracture surfaces. During long-term use, external toner additives accumulate selectively on the fracture surfaces, greatly affecting the charge-providing function of the magnetic carrier. Because the porous magnetic core particles are exposed at the fracture surfaces, moreover, the charge-providing function may be insufficient and image defects may occur under high-temperature, high-humidity conditions in particular.

If the toner has an average circularity of less than 0.940, the rise in triboelectric charge may be delayed because the contact area with indentations on the magnetic carrier particle surfaces is reduced. In the case of continuous output of images with a high image ratio in particular, fogging may occur during large-volume replenishment because the replenishing toner has not acquired sufficient triboelectric charge.

The magnetic carrier of the present invention is obtained via a step in which pores in porous magnetic core particles are filled with a silicone resin. The filled amount of resin is preferably in a range from 6 mass % to 25 mass % of the porous magnetic core particles in order to provide low specific gravity and the necessary magnetization of the magnetic carrier. Ranging from 8 mass % to 15 mass % is preferred.

The method of filling the pores in the porous magnetic core particles with resin is not particularly limited, and for example the porous magnetic core particles can be impregnated with a resin solution by dipping, spraying, brush painting or application in a fluidized bed, after which the solvent is evaporated. It is desirable to adopt a method in which the silicone resin is diluted with a solvent before being added to the pores of the porous magnetic core particles. The solvent used may be any capable of dissolving the silicone resin. The filling step is accomplished by mixing and agitating the porous magnetic core particles and resin solution under reduced pressure. Filling under reduced pressure makes it easier for the silicone resin to permeate the pores of the porous magnetic cores, so that the resin can fill the pores in the porous magnetic core particles completely. It is also possible to control variation in the filled condition of the resin between individual filled particles. Filling of the resin can also be performed multiple times. In this way, the resin can be made to fill into the interior of the pores of the porous magnetic core particles, minimizing the amount of residual air in the filled core particles.

The silicone resin used to fill the porous magnetic core particles may be methyl silicone resin, methylphenyl silicone resin, or modified silicone resin modified with acryl, epoxy or the like.

Silicone resin has high affinity for porous magnetic core particles, so residual air inside the filled core particles can be reduced. The catalyst can be selected to adjust the curing speed, which is convenient for controlling the degree of irregularities on the filled core particles, the physical properties of the coat layer, and adhesiveness with the coat layer.

Filled core particles filled with the silicone resin A can be obtained by heat-treating the silicone resin filling the pores in the porous magnetic core particles, either without a catalyst or in the presence of a non-metal catalyst. The temperature for curing the resin is preferably in a range from 150° C. to 250° C., and the heat-treatment time is preferably in a range from 1 hour to 3 hours. This leaves silanol groups on the surfaces of the filler core particles, increasing adhesiveness with the silicone resin B in the subsequent resin coating step.

The non-metal catalyst is a catalyst containing no metal elements, and is selected from the amines, carboxylic acids and the like. Two or more different non-metal catalysts may also be combined.

The following compounds are examples of amines that can be used for the non-metal catalyst: methylamine, ethylamine, propylamine, hexylamine, butanolamine, butylamine and other primary amines; dimethylamne, diethylamine, diethanolamine, dipropylamine, dibutylamine, dihexylamine, ethylamylamine, imidazole, propylhexylamine and other secondary amines; trimethylamine, triethylamine, tripropylamine, tributylamine, trihexylamine, methyldipropylamine, tripropanolamine, pyridine, N-methylimidazole, methylpropylhexylamine and other tertiary amines; and 3-aminopropyl triethoxysilane, 3-(2-aminoethyl)aminopropyl methyldimethoxysilane, 3-(2-aminoethyl)aminopropyl trimethoxysilane, 3-(2-aminoethyl)aminopropyl triethoxysilane, 3-phenylpropyl trimethoxysilane and other aminoalkylsilanes. An aminoalkylsilane is especially preferred from the standpoint of compatibility with the silicone resin solution, catalytic ability, stability and charge control properties.

Examples of carboxylic acids that can be used for the non-metal catalyst include acetic acid, propanoic acid, butanoic acid, formic acid, stearic acid, tetradecanoic acid, hexadecanoic acid, dodecanoic acid, decanoic acid, 3,6-dioxaheptanoic acid and 3,6,9-trioxadecanoic acid.

A charge control agent or charge control resin can be added to the resin solution when resin filling the porous magnetic core particles.

The charge control resin is preferably a nitrogen-containing resin for purposes of increasing the negative charge-providing function to the toner. To increase the positive charge-providing function to the toner, the charge control resin is preferably a sulfur-containing resin. For purposes of increasing the negative charge-providing function to the toner, the charge control agent is preferably a nitrogen-containing compound. To increase the positive charge-providing function to the toner, the charge control agent is preferably a sulfur-containing compound. For purposes of controlling the charge quantity, the added amount of the charge control resin or charge control agent is preferably in a range from 0.5 mass parts to 50.0 mass parts per 100 mass parts of the silicone resin used for filling.

The following are examples of negative charge control agents: N-β(aminoethyl)γ-aminopropyl trimethoxysilane, N-β(aminoethyl)γ-aminopropyl triethoxysilane, N-β(aminoethyl)γ-aminopropyl triisopropoxysilane, N-β(aminoethyl)γ-aminopropyl tributoxysilane, N-β(aminoethyl)γ-aminopropyl methyldimethoxysilane, N-β(aminoethyl)γ-aminopropyl methyldiethoxysilane, N-β(aminoethyl)γ-aminopropyl methyldiisopropoxysilane, N-β(aminoethyl)γ-aminopropyl methyldibutoxysilane, N-β(aminoethyl)γ-aminopropyl ethyldimethoxysilane, N-β(aminoethyl)γ-aminopropyl ethyldiethoxysilane, N-β(aminoethyl)γ-aminopropyl ethyldiisopropoxysilane, N-β(aminoethyl)γ-aminopropyl ethyldibutoxysilane, γ-aminopropyl trimethoxysilane, γ-aminopropyl triethoxysilane, γ-aminopropyl triisopropoxysilane, γ-aminopropyl tributoxysilane, γ-aminopropyl methyldimethoxysilane, γ-aminopropyl methyldiethoxysilane, γ-aminopropyl methyldiisopropoxysilane, γ-aminopropyl methyldibutoxysilane, γ-aminopropyl ethyldimethoxysilane, γ-aminopropyl ethyldiethoxysilane, γ-aminopropyl ethydiisopropoxysilane, γ-aminopropyl ethyldibutoxysilane, γ-aminopropyl triacetoxysilane, γ-(2-ureidoethyl)aminopropyl trimethoxysilane, γ-(2-ureidoethyl)aminopropyl triethoxysilane, γ-ureidopropyl triethoxysilane and N-β-(N-vinylbenzylaminoethyl)-γ-aminopropyl trimethoxysilane.

Adhesion between the coat layer and filled core particles is extremely good when an aminosilane coupling agent is added to the silicone resin solution and filled core particles are coated with this resin solution. There is also little peeling or wear of the coat layer on the magnetic particles even during long-term use. When such a magnetic carrier is used as a developer, moreover, the triboelectric charge properties are good, with a sharp charge quantity distribution. It is thought that in a magnetic carrier with a coat layer formed in the presence of a metal catalyst having titanium or zirconium, the added aminosilane coupling agent functions as a charge-providing agent on the magnetic carrier particle surfaces. It is also thought that at the boundary between the filled core particles and the coat layer, the aminosilane coupling agent functions as a primer to improve adhesiveness, while inside the coat layer it acts as a catalyst to produce a resin with excellent wear resistance. A magnetic carrier with charge-providing properties and adhesiveness as well as good wear resistance can be obtained by forming a coat layer with an aminosilane coupling agent added to the coating solution in the presence of a metal catalyst having titanium or zirconium.

Examples of metal catalysts having titanium or zirconium include titanium alkoxide catalysts, titanium chelate catalysts, zirconium alkoxide catalysts and zirconium chelate catalysts.

Examples of titanium alkoxide catalysts include titanium tetraisoproxide, titanium tetra-normal-dibutoxide, titanium butoxide dimer and titanium tetra-2-ethylhexoxide.

Examples of titanium chelate catalysts include diisopropoxytitanium diacetylacetonate, titanium dioctanoxy bisdioctanate, titanium tetracetylacetonate and titanium diisopropoxy ethylacetocetate.

Examples of zirconium alkoxide catalysts include zirconium tetra-normal-propoxide and zirconium tetra-normal-butoxide.

Examples of zirconium chelate catalysts include zirconium tetracetylacetonate, zirconium tributoxy monoacetylacetonate, zirconium monobutoxy acetylacetonate bis(ethyl acetoacetate), zirconium dibutoxybis(ethylacetoacetate) and zirconium tetraacetyl acetonate.

The silicone resin B is preferably a resin that is cured with a catalyst including one or more titanium catalysts selected from the titanium alkoxide catalysts and titanium chelate catalysts.

By selecting a titanium catalyst as the catalyst for curing the silicone resin B, it is possible to control accumulation of titanium oxide on the coat layer in the system when titanium oxide is added externally and mixed with the toner. This serves to control fluctuations in carrier resistance from endurance, producing a coat that can yield stable images over a long period of time. Production of unified particles is also suppressed in the resin coating step, resulting in a coat that can yield a magnetic carrier with a smoother surface.

Of the titanium catalysts, a resin that is cured with a titanium chelate catalyst is especially preferred. Titanium chelate catalysts are stable compounds. As a result, there is little change in state when a mixture of the silicone resin solution and catalyst is stored in a high-temperature tank, and the catalyst itself is resistant to decomposition.

Methods of coating the resin on the surface of the filled core particles include methods of coating by dipping, spraying, brush painting, dry coating or application in a fluidized bed. Of these, a coating method by dipping is preferred because it preserves the surface profile of the filled core particles to a certain extent.

The silicone resin B may be of the same kind as the silicone resin A, or may be different. Specific examples include methyl silicone resin, methyphenyl silicone resin, and modified silicone resin modified with acryl, epoxy or the like.

The amount of the silicone resin B used in coating treatment is preferably in a range from 0.1 mass parts to 5.0 mass parts per 100 mass parts of the filled core particles. The amount of the silicone resin B is also preferably in a range from 0.5 mass parts to 3.0 mass parts per 100 mass parts of the prepared magnetic carrier.

Particles having electrical conductivity, particles with charge control properties or charge control agents, charge control resins, various coupling agents and the like can be included in the silicone resin B in order to control the resistance and charge properties of the magnetic carrier.

It is desirable to use a nitrogen-containing coupling agent as the coupling agent in the silicone resin B in order to enhance the negative charge-providing function of the magnetic carrier. The added amount of the coupling agent is preferably in a range from 0.5 mass parts to 50.0 mass parts per 100 mass parts of the silicone resin B. Of the nitrogen-containing coupling agents, it is desirable to choose an aminosilane coupling agent. This serves to improve adhesion between the filled core particles and the coat layer of silicone resin B, and to improve the durability of the magnetic carrier by controlling peeling of the coat layer. The reason for this is thought to be that the aminosilane coupling agent in the resin solution reacts on the surface of the filled core particles during the resin coating step, forming something like a primer layer, and this primer layer improves adhesion between the filled core particles an the coat layer.

The surfaces of the filled core particles can also be treated in advance with a nitrogen-containing coupling agent before being coated with the silicone resin B. The surfaces of the filled core particles are thus treated uniformly with the coupling agent, and can then be coated with the silicone resin B without irregularities or gaps. This improves adhesion between the filled core particles and the coat layer.

The temperature for curing the silicone resin B is preferably in a range from 150° C. to 250° C., and the heat treatment time is preferably in a range from 1 hour to 4 hours. In order for an aminosilane coupling agent or other nitrogen-containing coupling agent to function as a primer layer, the concentration of the nitrogen-containing coupling agent on the underside of the coat layer (next to the filled core particle) must be higher than that of the surface layer. It has been confirmed from actual SIMS analysis that when the silicone resin is cured under these conditions, nitrogen derived from the aminosilane coupling agent is distributed at high concentrations on the underside of the coat layer.

Examples of particles having electrical conductivity include carbon black, magnetite, graphite, zinc oxide and tin oxide. For purposes of adjusting resistance, the added amount of particles having conductivity is preferably in a range from 0.1 mass parts to 10.0 mass parts per 100 mass parts of the silicone resin B. Examples of particles having a charge control function include organic metal complex particles, organic metal salt particles, chelate compound particles, monoazo metal complex particles, acetylacetone metal complex particles, hydroxycarboxylic acid metal complex particles, polycarboxylic acid metal complex particles, polyol metal complex particles, polymethylmethacrylate resin particles, polystyrene resin particles, melamine resin particles, phenol resin particles, nylon resin particles, silica particles, titanium oxide particles and alumina particles. The added amount of the particles having a charge control function is preferable in a range from 0.5 mass parts to 50.0 mass parts per 100 mass parts of the silicone resin B for purposes of adjusting the triboelectric charge quantity.

Examples of charge control agents that can be included in the silicone resin B include nigrosine dyes, metal salts of naphthenic acid or higher fatty acids, alkoxylated amines, quaternary ammonium salt compounds, azo metal complexes, and salicylic acid metal salts and metal complexes. For enhancing the negative charge-providing function, the charge control agent is preferably a nitrogen-containing compound. For enhancing the positive charge-providing function, it is preferably a sulfur-containing compound. The added amount of the charge control agent is preferably in a range from 0.5 mass parts to 50.0 mass parts per 100 mass parts of the silicone resin B for purposes of providing good dispersibility and adjusting the charge quantity. Examples of charge control resins that can be included in the silicone resin B include resins containing amino groups and resins with introduced quaternary ammonium groups. The added amount of the charge control resin is preferably in a range from 0.5 mass parts to 30.0 mass parts per 100 mass parts of the silicone resin B in order to confer both a charge-providing function and a mold release effect on the silicone resin B.

The 50% particle diameter on a volume basis (D50) of the magnetic carrier is preferably in a range from 20.0 μm to 70.0 μm from the standpoint of controlling carrier adhesion and toner spent, and from the standpoint of stability during long-term use.

The intensity of magnetization of the carrier at 1000/4Π (kA/m) is preferably in a range from 40 Am²/kg to 65 Am²/kg for purposes of improving dot reproducibility, preventing carrier adhesion, and preventing toner spent to obtain stable images.

The true specific gravity of the magnetic carrier is preferably in a range from 3.2 g/cm³ to 4.5 g/cm³ for purposes of preventing toner spent and maintaining stable images in the long term. Ranging from 3.5 g/cm³ to 4.2 g/cm³ is more desirable.

The apparent specific gravity of the magnetic carrier is preferably in a range from 1.2 g/cm³ to 2.3 g/cm³ for purposes of preventing toner spent and maintaining stable images long-term. Ranging from 1.5 g/cm³ to 2.0 g/cm³ is more desirable.

In the pore diameter distribution of the porous magnetic core particles as measured by the mercury intrusion method, the pore diameter at which the log differential pore volume is maximum within the range of pore diameter from 0.10 μm to 3.00 μm is preferably in a range from 0.70 μm to 1.30 μm. The cumulative pore volume of pore diameter ranging from 0.10 μm to 3.00 μm is preferably in a range from 0.03 ml/g to 0.12 ml/g.

If the pore diameter at which the log differential pore volume is maximum is in a range from 0.70 μm to 1.30 μm, the filler resin easily permeates the interior of the core, which is thus thoroughly filled with the resin, resulting in improved strength of the filled core particles. As a result, cracks and defects in the magnetic carrier due to mechanical stress can be controlled even if the developer is used for a long period of time. If the cumulative pore volume is in a range from 0.03 ml/g to 0.12 ml/g, the magnetic carrier will have a low specific gravity, reducing the stress on the toner within the developing device, and improving the durability of the developer. Moreover, high-resolution images can be obtained because soft magnetic chains are formed in the developing sites during image formation.

Porous magnetic ferrite core is preferably used for the porous magnetic core particles in the present invention. Ferrite is the sintered compact shown by the following formula:

(M1₂O)ₓ(M2O)_{y}(Fe₂O₃)_{z}

(wherein M1 is a univalent metal, M2 is a bivalent metal, and when x+y+z=1.0, x and y are each such that 0≦(x,y)≦0.8, and z is such that 0.2<z<1.0).

In the formula above, it is desirable to use 1 or more metal elements selected from the group consisting of Li, Fe, Mn, Mg, Sr and Ca as M1 and M2.

The following ferrites are specific examples: Li ferrite (for example, (Li₂O)ₐ(Fe₂O₃)_{b} (0.0<a<0.4, 0.6≦b<1.0, a+b=1), (Li₂O)ₐ(SrO)_{b}(Fe₂O₃)_{c} (0.0<a<0.4, 0.0<b<0.2, 0.4≦c<1.0, a+b+c=1)); Mn ferrite (for example, (MnO)ₐ(Fe₂O₃)_{b} (0.0<a<0.5, 0.5≦b<1.0, a+b=1)); Mn—Mg ferrite (for example, (MnO)ₐ(MgO)_{b}(Fe₂O₃)_{c} (0.0<a<0.5, 0.0<b<0.5, 0.5≦c<1.0, a+b+c=1)); Mn—Mg—Sr ferrite (for example, (MnO)ₐ(MgO)_{b}(SrO_{c})(Fe₂O₃)ₐ (0.0<a<0.5, 0.0<b<0.5, 0.0<c<0.5, 0.5≦d<1.0, a+b+c+d=1). These ferrites may contain trace amounts of metal.

An Mn ferrite, Mn—Mg ferrite or Mn—Mg—Sr ferrite containing Mn element is desirable from the standpoint of balancing and facilitating control of the pore diameter, cumulative pore volume and magnetization of the porous magnetic core particles.

The 50% particle diameter on a volume basis (D50) of the porous magnetic core particles is preferably in a range from 18.0 μm to 68.0 μm from the standpoint of preventing carrier adhesion and toner spent. When porous magnetic core particles of this diameter are filled with resin and coated with resin, the 50% particle diameter on a volume basis (D50) is roughly in a range from 20.0 μm to 70.0 μm.

The intensity of magnetization of the porous magnetic core particles at 1000/4Π (kA/m) is preferably in a range from 50 Am²/kg to 75 Am²/kg. Keeping the intensity of magnetization within this range serves to improve dot reproducibility (which affects the image quality of half-tone areas), while preventing carrier adhesion and toner spent and providing stable images with the magnetic carrier.

The true specific gravity of the porous magnetic core particles is preferably in a range from 4.5 g/cm³ to 5.5 g/cm³ so as to achieve the preferred true specific gravity of the final magnetic carrier.

The steps for manufacturing the porous magnetic ferrite are explained below.

Step 1 (Weighing and Mixing Step):

The ferrite raw materials are weighed and mixed. The following are examples of ferrite raw materials: particles of metal elements, oxides of metal elements, hydroxides of metal elements, oxalates of metal elements and carbonates of metal elements selected from Li, Fe, Mn, Mg, Sr and Ca, respectively. The apparatus for mixing the ferrite raw materials may be a ball mill, planetary mill, jet mill or vibrating mill. Of these, a ball mill is preferred from the standpoint of mixability.

Step 2 (Pre-Baking Step):

The mixed ferrite raw materials are pre-baked in atmosphere for ranging from 0.5 hours to 5.0 hours at a baking temperature in the range of 700° C. to 1000° C. to convert them to ferrite. The following furnaces for example can be used for baking: a burner-type combustion furnace, a rotary combustion furnace or an electric furnace.

Step 3 (Pulverization Step):

The pre-baked ferrite prepared in Step 2 is pulverized in a pulverizing device. Examples of pulverizing devices include crushers, hammer mills, ball mills, bead mills, planetary mills and jet mills.

The 50% particle diameter on a volume basis (D50) of the finely pulverized pre-baked ferrite is preferably in a range from 0.5 μm to 5.0 μm. The aforementioned particle diameter of the finely pulverized pre-baked ferrite can preferably be achieved for example by controlling the material, particle diameter and operating time of the balls or beads used in the ball mill or bead mill. The particle diameter of the balls or beads is not particularly limited as long as it provides the desired particle diameter and distribution. For example, balls with a diameter ranging from 5 mm to 60 mm can be used favorably. Beads with a diameter ranging from 0.03 mm to 5 mm can also be used favorably.

When pulverizing using a ball mill or bead mill, the pulverization process is preferably a wet process in order to increase the pulverization efficiency and prevent the powdered product from being stirred up inside the mill.

Step 4 (Granulation Step):

Water, a dispersant and a binder are added to the finely pulverized pre-baked ferrite, together with sodium carbonate, resin particles and foaming agents as necessary as adjusters for adjusting the volume of the internal pores and the pore diameter on the particle surfaces. Polyvinyl alcohol for example is used as the binder. The pulverized particle diameter of the pre-baked ferrite particles is increased for example in order to increase the pore diameter of the pores in the porous magnetic core particles. Conversely, the pulverized particle diameter of the pre-baked ferrite fine particles can be decreased for example in order to reduce the pore diameter. By means of such methods, the pore diameter can be adjusted to the pore diameter at which the log differential pore volume is maximum within the range from 0.10 μm to 3.00 μm.

The resulting ferrite slurry is dried and granulated in a heated atmosphere at in a range from 100° C. to 200° C. using a spray drier. A spray drier for example can be used as the spray drier.

Step 5 (Main Baking Step):

Next, the granulated product is baked for 1 hour to 24 hours at in a range from 800° C. to 1300° C.

The volume of pores inside the porous magnetic core particles can be adjusted by setting the baking temperature and baking time. Raising the baking temperature or increasing the baking time results in more baking, resulting in a smaller volume of pores inside the porous magnetic core particles. It is thus possible to adjust the cumulative volume of pores ranging from 0.10 μm to 3.00 μm in diameter according to the mercury intrusion method. The specific resistance of the porous magnetic core particles can also be adjusted to the desired range by controlling the baking atmosphere. For example, the specific resistance of the porous magnetic core particles can be reduced by lowering the oxygen concentration or using a reducing atmosphere (in the presence of hydrogen). The preferred range of oxygen concentration is 0.2 vol % or less, or more preferably 0.05 vol % or less.

Step 6 (Selection Step):

After being baked as described above, the particles are crushed, and can then be subjected to magnetic selection, grading or sifting in a sieve to remove low-magnetization components, coarse particles and fine particles.

A method of diluting the silicone resin A with a solvent and adding it to the pores in the porous magnetic core particles can be adopted as the method of filling the pores in the porous magnetic core particles with the silicone resin A. The solvent used here may be any capable of dissolving the silicone resin A. Examples of organic solvents include toluene, xylene, cellusolve butyl acetate, methylethyl ketone, methylisobutyl ketone and methanol. When the silicone resin A is a water-soluble resin or emulsion-type resin, water can also be used as the solvent. An example of a method for filling the pores of the porous magnetic core particles with the silicone resin A is to impregnate the porous magnetic core particles with a resin solution by an application method such as dipping, spraying, brush painting or a fluidized bed, and then evaporating the solvent.

The amount of solids of the silicone resin A in the resin solution is preferably in a range from 1 mass % to 50 mass %, or more preferably in a range from 1 mass % to 30 mass %. At or below 50 mass %, the resin solution has the right degree of viscosity to allow the resin solution to infiltrate the pores in the porous magnetic core particles with ease. At and above 1 mass %, little time is required to remove the solvent, and filling is uniform.

The degree to which the porous magnetic core particles are exposed on the surfaces of the magnetic carrier particles can be controlled by controlling the solids concentration and the volatilization rate of the solvent during filling. The desired specific resistance of the magnetic carrier can thus be obtained. Toluene is preferred as the solvent because it is easy to control the volatilization rate.

The aforementioned filling step is followed by a resin coating step in which the surfaces of the filled core particles are coated with the silicone resin B. A coupling treatment step in which the filled core particles are subjected to coupling treatment with a nitrogen-containing coupling agent can be performed before the resin coating step.

The toner is explained next.

The average circularity of the toner used in the present invention is 0.940 or more. When the average circularity of the toner is within this range, the two-component developer has good fluidity and excellent triboelectric charge rising performance. Good cleaning properties are also easy to obtain if the average circularity is in a range from 0.940 to 0.965. An average circularity ranging from 0.960 to 1.000 is suitable for a cleaner-less system. If the average circularity is less than 0.940, the rise-up of charging is slow, and fogging is more likely to occur. Developing performance is also somewhat poor, and a higher field strength is required in the developing sites. When an image is developed at high field strength, patterns of spots or rings (ring marks) may occur on the paper.

In the case of a toner manufactured by a pulverization method for example, the average circularity of the toner can be adjusted by surface modification treatment after the pulverization step. The average circularity of the toner can be increased for example by high-temperature treatment during the surface modification process.

The weight-average particle diameter (D4) of the toner is preferably in a range from 3.0 μm to 8.0 μm from the standpoint of improving release from the magnetic carrier and providing good developing performance. Fluidity of the developer is also improved, and good charge rising performance is obtained.

The toner particles used in the present invention contain a binder resin, a release agent and a colorant.

To achieve both storability and low-temperature fixability of the toner, the binder resin preferably has a peak molecular weight (Mp) ranging from 2,000 to 50,000, a number-average molecular weight (Mn) ranging from 1,500 to 30,000 and a weight-average molecular weight (Mw) ranging from 2,000 to 1,000,000 in the molecular weight distribution as measured by gel permeation chromatography (GPC). The glass transition temperature (Tg) of the binder resin is preferably in a range from 40° C. to 80° C.

The colorant may be a known magenta toner coloring pigment, magenta toner dye, cyan toner coloring pigment, cyan coloring dye, yellow coloring pigment, yellow coloring dye or black colorant, or a colorant that has been color-adjusted to black with yellow, magenta and cyan colorants. A pigment may be used alone as a colorant, but it is desirable from the standpoint of full-color image quality to combine a dye and a pigment for improved color definition. The amount of the colorant is preferably in a range from 0.1 mass parts to 30.0 mass parts or more preferably in a range from 0.5 mass parts to 20.0 mass parts or still more preferably in a range from 3.0 mass parts to 15.0 mass parts per 100 mass parts of binder resin.

The amount of release agent used is preferably in a range from 0.5 mass parts to 20.0 mass parts or more preferably in a range from 2.0 mass parts to 8.0 mass parts per 100 mass parts of binder resin. The peak temperature of the highest endothermal peak of the release agent is preferably in a range from 45° C. to 140° C. Both storability of the toner and hot offset resistance can be achieved in this way.

A charge control agent can be added to the toner as necessary. A known compound can be used as the charge control agent contained in the toner, but it is especially desirable to use a metal compound of an aromatic carboxylic acid that is colorless, has a rapid toner charge speed and can stably retain a fixed charge quantity. The added amount of the charge control agent is preferably in a range from 0.2 mass parts to 10 mass parts by mass per 100 mass parts by mass of the binder resin.

An external additive is preferably added to the toner to improve fluidity. The external additive is preferably an inorganic fine powder such as silica, titanium oxide or aluminum oxide. The inorganic fine powder is preferably made hydrophobic with a hydrophobic agent such as a silane compound or silicone oil or a mixture of these.

Hydrophobic treatment is preferably performed by adding 1 mass % to 30 mass % (more preferably in a range from 3 mass % to 7 mass %) of the hydrophobic agent to the inorganic fine powder to treat the inorganic fine powder.

Following hydrophobic treatment, the hydrophobicity of the inorganic fine powder is preferably in a range from 40 to 98. The hydrophobicity indicates the wettability of a sample with respect to methanol.

The external additive is preferably used in the amount ranging from 0.1 mass parts to 5.0 mass parts per 100 mass parts of toner particles.

A known mixing device such as a Henschel mixer can be used for mixing the toner particles and external additive.

The toner used in the present invention can be obtained by a kneading pulverization method, solution suspension method, suspension polymerization method, emulsion-aggregation polymerization method or aggregation polymerization method, with no particular limitations on the method of manufacture.

The toner manufacturing procedure is explained below using a pulverization method (kneading pulverization method).

In the raw material mixing step, a binder resin, colorant and release agent together with a charge control agent and other components as necessary are weighed in specific amounts, and compounded and mixed as the raw materials of the toner particles. The following are examples of mixing devices: Super Mixer (Kawata Manufacturing Co., Ltd.), Henschel Mixer (Mitsui Mining), Nauta Mixer (Hosokawa Micron) and Mechano Hybrid (Mitsui Mining).

Next, the mixed materials are melt kneaded to disperse the colorant and the like in the binder resin. A pressure kneader, Banbury mixer or other batch kneader or continuous kneader can be used in this melt kneading step, but single-screw and twin-screw extruders have become the norm because of their superiority for continuous production. Examples include KTK twin-screw extruders (Kobe Steel, Ltd.), TEM twin-screw extruders (Toshiba Machine), PCM kneaders (Ikegai Iron Works), twin-screw extruders (KCK Co.), Co-Kneaders (Buss) and Kneadex kneaders (Mitsui Mining).

Next, the colored resin composition obtained by melt kneading is rolled between two rollers, and cooled with water or the like in a cooling step.

Next, the cooled kneaded product is pulverized to the desired particle diameter in a pulverization step. In the pulverization step it is first coarsely ground with a crusher, hammer mill, feather mill or other crushing device, and then finely pulverized with a Kryptron System (Kawasaki Heavy Industries), Super Rotor (Nisshin Engineering), Turbo Mill (Turbo Industries), air-jet system or other pulverizer.

This can then be classified as necessary with a sorting device such as an Elbow-Jet (Nittetsu Mining) using an inertial classification system, a Turboplex (Hosokawa Micron) using a centrifugal classification system, a TSP Separator (Hosokawa Micron) or a Faculty (Hosokawa Micron), or with a sieving device to obtain toner particles.

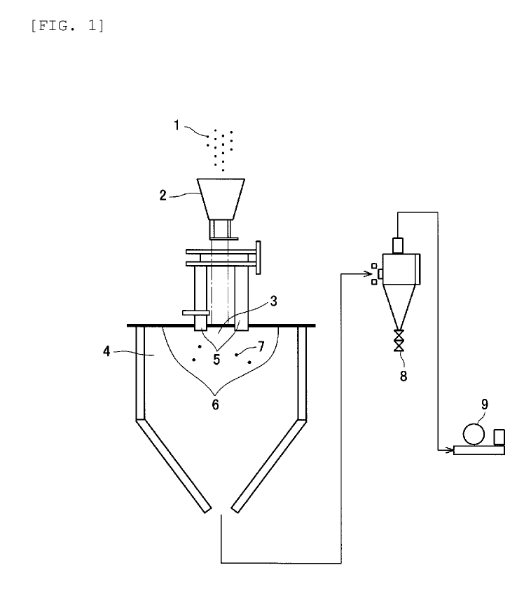

After pulverization, the toner particles can also be subjected to surface modification treatment such as sphering treatment using a hybridization system (Nara Machinery) or Mechano Fusion system (Hosokawa Micron). For example, the surface modification device shown in FIG. 1 can be used. A specific amount of a raw material toner 1 is supplied by an autofeeder 2 via a supply nozzle 3 to a surface modification device interior 4. Because the surface modification device interior 4 is suctioned by a blower 9, the raw material toner 1 introduced from the supply nozzle 3 is dispersed inside the device. The raw material toner 1 dispersed inside the device is surface modified by instantaneous application of heat using hot air introduced from a hot air introduction port 6. The surface-modified toner particles 7 are cooled instantaneously by cool air introduced from the cool air introduction port 6.

The surface-modified toner particles 7 are suctioned by the blower 9, and collected by a cyclone 8.

When the two-component developer is used as an initial developer, the mixing ratio of the toner and magnetic carrier is preferably in a range from 2 mass parts to 20 mass parts of toner or more preferably in a range from 4 mass parts to 15 mass parts of toner per 100 mass parts of magnetic carrier. When the two-component developer is used as a replenishing developer, the mixing ratio of the toner and the magnetic carrier is preferably in a range from 2 mass parts to 50 mass parts of toner per 1 mass part of magnetic carrier in order to enhance the durability of the developer.

The methods for measuring the various physical properties of the magnetic carrier and toner are explained below.

<Measuring Cumulative Pore Volume and Pore Diameter at which the Log Differential Pore Volume is Maximum within the Range from 0.10 μm to 3.00 μm in the Pore Diameter Distribution of the Porous Magnetic Cores>

The pore diameter distribution of the porous magnetic core particles is measured by the mercury intrusion method.

A Yuasa Ionics PoreMaster series or PoreMaster-GT series full-automated multifunctional porosimeter, a Shimadzu Autopore IV 9500 series automated porosimeter or the like can be used for the measurement equipment.

In the examples of this application, measurement was performed according to the following conditions and procedures using a Shimadzu Autopore IV 9520.

### <Measurement Conditions>

Measurement environment: about 20° C.

Measurement cell: sample volume 5 cm³, intrusion volume 1.1 cm³, use: powder measurement range 2.0 psia (13.8 kPa) to 59989.6 psia (413.7 Mpa)

Measurement steps: 80 steps (steps cut so as to be equally spaced when the pore diameter is given logarithmically), adjusted to from 25% to 70% of intrusion volume

Low-pressure parameter: discharge pressure 50 μmHg

Discharge time: 5.0 min

Mercury injection pressure: 2.00 psia (13.8 kPa)

Equilibrium time: 5 secs

High-pressure parameter: equilibrium time 5 secs

Mercury parameter: advancing contact angle 130.0 degrees

Receding contact angle 130.0 degrees

Surface tension: 485.0 mN/m (485.0 dynes/cm)

Mercury density: 13.5335 g/mL

### <Measurement Procedures>

(1) About 1.0 g of magnetic core particles are weighed and placed in a sample cell. Weight is entered in the software.

(2) A range from 2.0 psia (13.8 kPa) to 45.8 psia (315.6 kPa) is measured in the low-pressure part.

(3) A range from 45.9 psia (316.3 kPa) to 59989.6 psia (413.6 Mpa) is measured in the high-pressure part.

(4) The pore diameter distribution is calculated from the mercury injection pressure and the amount of mercury injected.

Steps (2), (3) and (4) above were performed automatically with the device accessory software.

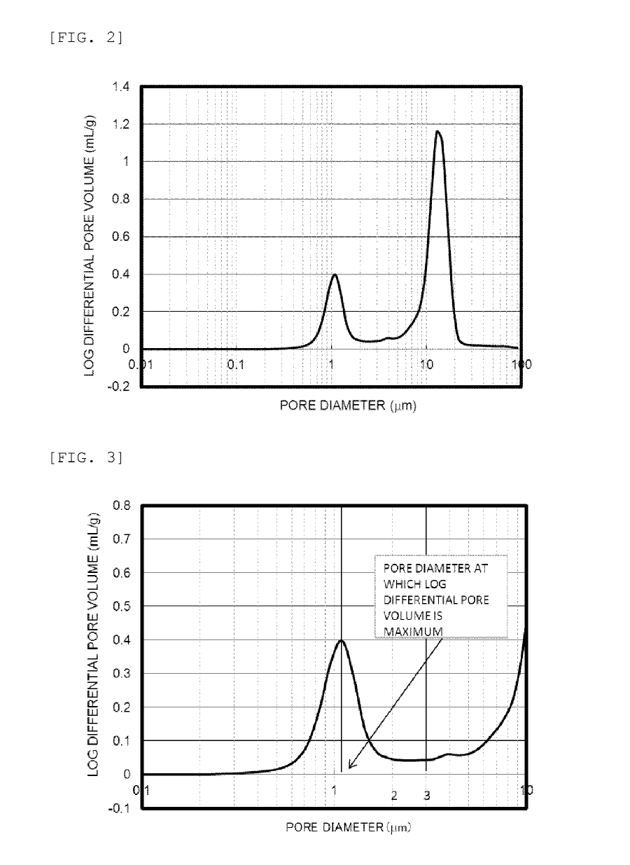

FIG. 2 shows one example of a pore diameter distribution calculated as described above, and FIG. 3 shows an enlarged view thereof. In FIGS. 2 and 3, the x-axis shows the pore diameter as determined by the mercury intrusion method, while the y-axis shows the log differential pore volume.

The peak within the pore diameter ranging from 10 μm to 20 μm represents the gaps between porous magnetic core particles.

As shown in FIG. 3, the pore diameter at the maximum peak within the pore diameter ranging from 0.10 μm to 3.00 μm is the pore diameter at which the log differential pore volume is maximum. In the pore diameter distribution, the total intrusion volume calculated within the pore diameter ranging from 0.10 μm to 3.00 μm is given as the cumulative pore volume.

<Method for Measuring 50% Particle Diameter on a Volume Basis (D50) of Porous Magnetic Core Particles and Magnetic Carrier>

The particle size distributions of the porous magnetic core particles and magnetic carrier are measured using a laser diffraction/scattering particle size distribution analyzer (Microtrac MT 3300 EX manufactured by Nikkiso Co., Ltd.).

The 50% particle diameters on a volume basis (D50) of the porous magnetic cores and magnetic carrier are measured with a sample supply system for dry measurement (Turbotrac one-shot dry sample conditioner, Nikkiso) as the equipment. Using a dust collector as the vacuum source, the Turbotrac supply conditions were air volume about 33 liters/sec, pressure about 17 kPa. Control was performed automatically by the software, and the 50% particle diameter (D50) (cumulative value on a volume basis) was determined. Control and analysis were performed with the accessory software (Version 10.3.3-202D).

The measurement conditions were SetZero time 10 seconds, measurement time 10 seconds, number of measurements 1, particle diffraction 1.81, particle shape non-spherical, upper measurement limit 1408 μm, lower measurement limit 0.243 μm. Measurement was performed in a normal temperature, normal humidity environment (23° C., 50% RH).

<Measuring Average Circularity of Toner>

The average circularity of the toner was measured with a flow particle image analyzer (FPIA-3000, Sysmex).

The specific measurement methods are as follows. About 20 ml of ion-exchanged water from which solid impurities and the like have already been removed is placed in a glass container. About 0.2 ml of a diluted solution of “Contaminon N” (a 10 mass % aqueous solution of a pH 7 neutral detergent for washing precision measurement equipment, comprising a nonionic surfactant, an anionic surfactant, and an organic builder, produced by Wako Pure Chemical Industries, Ltd.) diluted with ion-exchanged water by a factor of about 3 on a mass basis is added thereto as a dispersant. About 0.02 g of the measurement sample is then added, and dispersed for 2 minutes using an ultrasonic disperser, so as to prepare a dispersion for measurement. Cooling is performed as necessary during this process so that the temperature of the dispersion is ranging from 10° C. to 40° C. Using a desktop ultrasonic cleaning and dispersing machine having an oscillatory frequency of 50 kHz and an electrical output of 150 W (for example, “VS-150” produced by VELVO-CLEAR) as the ultrasound disperser, a predetermined amount of ion-exchanged water is put into a water tank, and about 2 ml of the Contaminon N described above is added to this water tank.

For the measurements, the aforementioned flow particle image analyzer equipped with a standard objective lens (10×, aperture 0.40) is used together with Particle Sheath “PSE-900A” (Sysmex) as a sheath liquid. A dispersion prepared by the procedures described above is introduced into the flow particle image analyzer, and 3,000 toner particles are measured in HPF measurement mode, total counter mode. The average circularity of the toner particles is then determined given 85% as the binarization threshold value in particle analysis, and with the range of analyzed particle diameters limited to in a range from 1.985 μm to 39.69 μm on a circle-equivalent diameter basis.

Prior to the start of measurement, automatic focal point adjustment is performed using standard latex particles (for example, Duke Scientific “Research and Test Particles Latex Microsphere Suspensions 5200A”, diluted with ion-exchanged water). Thereafter, focal point adjustment is preferably performed every two hours after the start of measurement.

In the examples, a flow particle image analyzer that had been calibrated by Sysmex Corp. and had been issued a calibration certificate by Sysmex Corp. was used. The measurements were performed under the same measurement and analysis conditions as those when the calibration certificate was received, except that the analyzed particle diameter was limited to in a range from 1.985 μm to 39.69 μm on a circle equivalent diameter basis.

<Measuring Weight-Average Particle Diameter (D4) of Toner>

The weight-average particle diameter (D4) of the toner was calculated based on an analysis of measurement data obtained with precise particle size distribution measurement apparatus with 100 μm aperture tube (“Coulter Counter Multisizer 3™”, Beckman Coulter, Inc.) based on the pore electrical resistance method, using the attached dedicated software (“Beckman Coulter Multisizer 3 Version 3.51” Beckman Coulter, Inc.)) for setting the measurement conditions and analyzing the measurement data, and with 25,000 as the number of effective measurement channels.

A solution prepared by dissolving special grade sodium chloride in ion-exchanged water so as to achieve a concentration of about 1 mass %, such as “ISOTON II” (Beckman Coulter, Inc.) for example, can be used as the aqueous electrolyte solution for measurement.

The dedicated software described above is set as follows prior to measurement and analysis. In the “modification of standard operating method (SOM)” screen of the dedicated software, the total count number in control mode is set at 50,000 particles, the number of measurements is set at 1 measurement, and the Kd value is set at a value obtained using “Standard 10.0 μm Particles” (Beckman Coulter, Inc.). The threshold value and noise level are set automatically by pressing the “threshold value/noise level measurement button”. In addition, the current is set at 1,600 μA, the gain at 2 and the electrolytic solution at ISOTON II, and a check is entered for “post-measurement aperture tube flush”.

In the “setting conversion from pulses to particle diameter” screen of the dedicated software, the bin interval is set at logarithmic particle diameter, the particle diameter bins are set at 256, and the particle diameter range is set at ranging from 2 μm to 60 μm.

The detailed measurement methods are as follows.

(1) About 200 ml of the aqueous electrolytic solution is placed in a Multisizer 3 dedicated 250 ml round-bottom glass beaker, which is then set on a sample stand, and counterclockwise agitation is performed with a stirrer rod at 24 rotations/sec. Then, contamination and air bubbles in the aperture tube are removed by the “aperture flush” function of the dedicated software.

(2) About 30 ml of the aqueous electrolytic solution is placed a 100 ml flat-bottom glass beaker, and about 0.3 ml of a diluted solution of “Contaminon N” (a 10 mass % aqueous solution of a pH 7 neutral detergent for washing precision measurement equipment, comprising a nonionic surfactant, an anionic surfactant and an organic builder, produced by Wako Pure Chemical Industries, Ltd.) diluted with ion-exchanged water by a factor of 3 on a mass basis is added thereto as a dispersant.

(3) A specific amount of ion-exchanged water is put into the water tank of an “Ultrasonic Dispersion System Tetora 150” ultrasonic disperser (Nikkaki Bios Co., Ltd.) having an electrical output of 120 W and containing two oscillators having an oscillatory frequency of 50 kHz with the phases of the two displaced by 180 degrees, and about 2 ml of Contaminon N is added to this water tank.

(4) The beaker from item (2) above is set into a beaker-fixing hole of the ultrasonic disperser, and the ultrasonic disperser is operated. Then, the height position of the beaker is adjusted in such a way as to maximize the condition of resonance of the liquid surface of the aqueous electrolytic solution in the beaker.

(5) The aqueous electrolytic solution in the beaker of item (4) above is exposed to ultrasound while about 10 mg of toner is added little by little and dispersed in the aqueous electrolytic solution. The ultrasonic dispersion treatment is then continued for 60 seconds. During ultrasonic dispersion, the water temperature of the water tank is adjusted appropriately to in a range from 10° C. to 40° C.

(6) The aqueous electrolytic solution of (5) above with the toner dispersed therein is dripped with a pipette into the round-bottom beaker of (1) above set in the sample stand in such a way that the measurement concentration is adjusted to about 5%. Then, measurement is performed until the number of measured particles reaches 50,000.

(7) The measurement data are analyzed by the dedicated software accompanying the apparatus, and the weight average particle diameter (D4) is calculated. When graph/volume % is set in the dedicated software, the “average diameter” on the “analysis/statistical value on volume (arithmetic average)” screen is the weight average particle diameter (D4).

<Methods for Measuring Peak Molecular Weight (Mp), Number-Average Molecular Weight (Mn) and Weight-Average Molecular Weight (Mw) of Resin>

The molecular weight distribution of the resin is measured as follows by gel permeation chromatography (GPC).

The resin is dissolved in tetrahydrofuran (THF) at room temperature over 24 hours. The resulting solution is then filtered with a solvent-resistant membrane filter “Maeshori Disk” (Tosoh Corp.) having a pore diameter of 0.2 μm to obtain a sample solution. The sample solution is adjusted so that the concentration of components soluble in THF is about 0.8 mass %. Measurement is performed using this sample solution under the following conditions.

Equipment: HLC8120 GPC (detector: RI) (Tosoh Corp.)

Columns: 7 Shodex columns: KF-801, 802, 803, 804, 805, 806, and 807 (Showa Denko K.K.)

Eluant: Tetrahydrofuran (THF)

Flow rate: 1.0 ml/min

Oven temperature: 40.0° C.

Amount of sample injected: 0.10 ml

A molecular weight calibration curve prepared using standard polystyrene resin (for example, “TSK Standard Polystyrene F-850, F-450, F-288, F-128, F-80, F-40, F-20, F-10, F-4, F-2, F-1, A-5000, A-2500, A-1000, and A-500” (product name), produced by Tosoh Corporation) is used in calculating the molecular weight of the samples.

<Maximum Endothermic Peak Temperature of Wax, Glass Transition Temperature Tg of Binder Resin>

The maximum endothermic peak temperature of the wax is measured in accordance with ASTM D3418-82 using a “Q1000” differential scanning calorimeter (TA Instruments). Temperature correction of the equipment detection part is done using the melting points of indium and zinc. The heat of fusion of indium is used in correcting the amount of heat.

Specifically, about 10 mg of wax is precisely weighed and put into an aluminum pan. Measurement is performed within a measurement temperature in a range from 30° C. to 200° C. at a rate of temperature increase of 10° C./min, using an empty aluminum pan as a reference. During measurement, the temperature is once raised to 200° C., then lowered to 30° C., and then raised again. The maximum endothermic peak of the DSC curve within the temperature ranging from 30° C. to 200° C. in this second temperature raising step is taken as the maximum endothermic peak the wax.

To determine the glass transition temperature (Tg) of the binder resin, about 10 mg of binder resin is precisely weighed and measured as in the case of the wax measurement. A specific heat change is obtained in the temperature ranging from 40° C. to 100° C. The intersection between the differential thermal curve and the line at the midpoint of the baseline before and after this specific heat change appeared is given as the glass transition temperature Tg of the binder resin.

<Method of Measuring Intensity of Magnetization of Magnetic Carrier and Porous Magnetic Core Particles>

The intensity of magnetization of the magnetic carrier and porous magnetic core particles can be determined with a vibrating sample magnetometer or a direct current magnetization characteristics recording device (B-H Tracer). In the examples of the present invention, measurement is performed with a BHV-30 vibrating sample magnetometer (Riken Denshi Co., Ltd.) according to the following procedure.

A cylindrical plastic container closely packed with the magnetic carrier or porous magnetic core particles is used for the sample. The actual mass of the sample packed in the container is measured. Thereafter, the sample in the plastic container is bonded with an instant adhesive so that the sample cannot move.

The external magnetic field axis and the magnetization moment axis at 5,000/4Π (kA/m) are calibrated by using a standard sample.

The intensity of magnetization is measured from the loop of the magnetization moment, where the sweep rate is specified as 5 min/roop and an external magnetic field of 1,000/4Π (kA/m) is applied. The results are divided by the sample weight so as to determine the intensity of magnetization (Am²/kg) of the magnetic carrier and porous magnetic core particles.

<Method of Measuring True Density of Porous Magnetic Core Particles>

The true density of the porous magnetic core particles is measured with an Accupyc 1330 automated dry density analyzer (Shimadzu Corp.). First, 5 g of a sample that has been left standing for 24 hours in an environment of 23° C./50% RH is precisely weighed and put into a measurement cell (10 cm³), which is then inserted into the sample chamber of the analyzer. Measurement can be performed automatically by inputting the sample weight into the analyzer and starting the measurement.

The conditions for automatic measurement involve purging the sample chamber 10 times using a helium gas adjusted at 20.000 psig (2.392×10² kPa), taking the state in which the pressure change in the sample chamber reaches 0.005 psig/min (3.447×10⁻² kPa/min) as the equilibrium state, and purging repeatedly with helium gas until the equilibrium state is reached. The pressure of the sample chamber of the analyzer in the equilibrium state is measured. The sample volume can be calculated from the change of pressure when the equilibrium state is reached (Boyle's law). Since the sample volume can be calculated, the true specific gravity of the sample can be calculated according to the following formula:

True specific gravity of sample (g/cm³)=sample weight (g)/sample volume (cm³).

The average of the measurement values obtained by repeating the automatic measurement 5 times is given as the true specific gravity (g/cm³) of the porous magnetic core particles.

<Method of Measuring Apparent Density of Porous Magnetic Core Particles and Magnetic Carrier>

The apparent densities of the porous magnetic core particles and magnetic carrier are determined in accordance with JIS-Z2504 (Methods for Testing Apparent Density of Metal Powders), with the porous magnetic core particles and magnetic carrier used instead of metal powders.

### EXAMPLES

### Manufacturing Example

### Magnetic Core Particles 1

Step 1 (Weighing and Mixing Step):

| | |
|---|---|
| Fe₂O₃ | 59.7 mass % |
| MnCO₃ | 34.4 mass % |
| Mg(OH)₂ | 4.8 mass % |
| SrCO₃ | 1.1 mass % |

The above ferrite raw materials were weighed. They were then pulverized and mixed for 2 hours in a dry ball mill using zirconia balls (diameter 10 mm).

Step 2 (Pre-Baking Step):

After pulverization and mixing, this was baked for 2 hours at 950° C. in atmosphere in a burner-type combustion furnace to prepare pre-baked ferrite.

The composition of the ferrite was as follows:

(MnO)ₐ(MgO)_{b}(SrO_{c})(Fe₂O₃)_{d}

(in which a=0.39, b=0.11, c=0.01 and d=0.49).

Step 3 (Pulverization Step):

The pre-baked ferrite was pulverized to about 0.5 mm in a crusher, and then pulverized for 2 hours in a wet ball mill using zirconia (φ10 mm) balls, with 30 mass parts of water added per 100 mass parts of pre-baked ferrite.

This slurry was pulverized for 3 hours in a wet ball mill using zirconia beads (φ1.0 mm) to obtain ferrite slurry (finely pulverized pre-baked ferrite).

Step 4 (Granulation Step):

2.0 mass parts of polyvinyl alcohol per 100 mass parts of pre-baked ferrite were added to the ferrite slurry as a binder, and spherical particles were granulated in a spray dryer (manufactured by Ohkawara Kakohki).

Step 5 (Main Baking Step):

In order to control the baking atmosphere, this was baked for 4 hours at 1100° C. in an electric furnace in a nitrogen atmosphere (oxygen concentration 0.02 vol %).

Step 6 (Selection Step):

The aggregated particles are crushed, and sifted in a 250 μm sieve to remove coarse particles and obtain the porous magnetic core particles 1. The physical properties of the porous magnetic core particles 1 are shown in Table 1.

### Manufacturing Examples

### Porous Magnetic Core Particles 2 to 10 and Magnetic Core Particles 11

Porous magnetic core particles 2 to 10 and magnetic core particles 11 were obtained in roughly the same way as porous magnetic core particles 1 except that the conditions in the pulverization step and main baking step of the manufacturing example of porous magnetic core particles 1 were changed as shown in Table 1. The physical properties of the resulting porous magnetic core particles and magnetic cores are shown in Table 2.

TABLE 1

| | | | Magnetic core manufacturing examples | | | | | |
|---|---|---|---|---|---|---|---|---|
| | | | Porous | Porous | Porous | Porous | Porous | Porous |
| | | | magnetic | magnetic | magnetic | magnetic | magnetic | magnetic |
| | | | core 1 | core 2 | core 3 | core 4 | core 5 | core 6 |
| Composition | Fe₂O₃ | | 59.7 | 59.7 | 59.7 | 59.7 | 59.7 | 45.5 |
| (mass %) | CuO | | — | — | — | — | — | — |
| | ZnO | | — | — | — | — | — | — |
| | MnCO₃ | | 34.4 | 34.4 | 34.4 | 34.4 | 34.4 | 45.3 |
| | Mg(OH)₂ | | 4.8 | 4.8 | 4.8 | 4.8 | 4.8 | 4.0 |
| | SrCO₃ | | 1.1 | 1.1 | 1.1 | 1.1 | 1.1 | 2.5 |
| Pre-baking | Temperature | | 950° C. | 950° C. | 950° C. | 950° C. | 950° C. | 950° C. |
| | Time | | 2 hours | 2 hours | 2 hours | 2 hours | 2 hours | 2 hours |
| Pulverization | Crusher | Size | 0.5 mm | 0.5 mm | 0.5 mm | 0.5 mm | 0.5 mm | 0.5 mm |
| | Ball mill | Type | Zirconia | Stainless | Alumina | Zirconia | Zirconia | Zirconia |
| | | Time | 2 hours | 3 hours | 1 hour | 2 hours | 2 hours | 2 hours |
| | Bead mill 1 | Type | Zirconia | Stainless | Alumina | Zirconia | Zirconia | Zirconia |
| | | Time | 3 hours | 2 hours | 3 hours | 3 hours | 3 hours | 3 hours |
| | Bead mill 2 | Type | — | — | — | — | — | — |
| | | Time | — | — | — | — | — | — |
| Granulation | Amount of PVA | | 2.0% | 2.0% | 2.0% | 2.0% | 2.0% | 2.0% |
| Baking | Baking 1 | Atmosphere | Oxygen | Oxygen | Oxygen | Oxygen | Oxygen | Oxygen |
| | | | 0.02 vol % | 0.02 vol % | 0.02 vol % | 0.02 vol % | 0.02 vol % | 0.02 vol % |
| | | Temperature | 1100° C. | 1150° C. | 1060° C. | 1250° C. | 1250° C. | 1300° C. |
| | | Time | 4 hours | 4 hours | 4 hours | 4 hours | 4 hours | 6 hours |

| | | | Magnetic core manufacturing examples | | | | |
|---|---|---|---|---|---|---|---|
| | | | Porous | Porous | Porous | Porous | |
| | | | magnetic | magnetic | magnetic | magnetic | Magnetic |
| | | | core 7 | core 8 | core 9 | core 10 | core 11 |
| Composition | Fe₂O₃ | | 45.5 | 45.5 | 52.5 | 47.2 | 71 |
| (mass %) | CuO | | — | — | — | — | 12.5 |
| | ZnO | | — | — | — | — | 16.5 |
| | MnCO₃ | | 45.3 | 45.3 | 45.9 | 47.4 | — |
| | Mg(OH)₂ | | 4.0 | 4.0 | 1.6 | 5.0 | — |
| | SrCO₃ | | 2.5 | 2.5 | — | 0.4 | — |
| Pre-baking | Temperature | | 950° C. | 950° C. | 950° C. | 950° C. | 950° C. |
| | Time | | 2 hours | 2 hours | 2 hours | 2 hours | 2 hours |
| Pulverization | Crusher | Size | 0.5 mm | 0.5 mm | 0.5 mm | 0.5 mm | 0.5 mm |
| | Ball mill | Type | Zirconia | Alumina | Stainless | — | Stainless |
| | | Time | 2 hours | 1 hour | 3 hours | — | 2 hours |
| | Bead mill 1 | Type | Zirconia | Alumina | Stainless | ⅛″ stainless | Stainless |
| | | Time | 3 hours | 2 hours | 3 hours | 1 hour | 4 hours |
| | Bead mill 2 | Type | — | — | — | 1/16″ | — |
| | | | | | | stainless | |
| | | | | | | beads | |
| | | Time | — | — | — | 4 hours | — |
| Granulation | Amount of PVA | | 2.0% | 2.0% | 2.0% | 0.60% | 0.50% |
| Baking | Baking 1 | Atmosphere | Oxygen | Oxygen | Oxygen | Oxygen 0% | Atmosphere |
| | | | 0.02 vol % | 0.02 vol % | 0.02 vol % | | |
| | | Temperature | 1050° C. | 1150° C. | 1150° C. | 1140° C. | 1300° C. |
| | | Time | 3 hours | 4 hours | 4 hours | 4 hours | 4 hours |

TABLE 2

| | | | | | Mercury intrusion | |
|---|---|---|---|---|---|---|
| | | | True | Apparent | | Peak top |
| | | | specific | specific | Total gap | pore |
| | | D50 | gravity | gravity | volume | diameter |
| | Composition | [μm] | [g/cm³] | [g/cm³] | [ml/g] | [μm] |
| Porous magnetic core 1 | (MnO)_{0.39}(MgO)_{0.11}(SrO)_{0.01}(Fe₂O₃)_{0.49} | 35.8 | 4.8 | 1.65 | 0.085 | 1.0 |
| Porous magnetic core 2 | (MnO)_{0.39}(MgO)_{0.11}(SrO)_{0.01}(Fe₂O₃)_{0.49} | 34.4 | 4.8 | 1.72 | 0.075 | 0.7 |
| Porous magnetic core 3 | (MnO)_{0.39}(MgO)_{0.11}(SrO)_{0.01}(Fe₂O₃)_{0.49} | 34.5 | 4.8 | 1.49 | 0.108 | 1.6 |
| Porous magnetic core 4 | (MnO)_{0.39}(MgO)_{0.11}(SrO)_{0.01}(Fe₂O₃)_{0.49} | 37.5 | 4.8 | 2.01 | 0.034 | 1.1 |
| Porous magnetic core 5 | (MnO)_{0.39}(MgO)_{0.11}(SrO)_{0.01}(Fe₂O₃)_{0.49} | 33.5 | 4.8 | 1.46 | 0.111 | 1.1 |
| Porous magnetic core 6 | (MnO)_{0.35}(MgO)_{0.12}(SrO)_{0.03}(Fe₂O₃)_{0.50} | 49.8 | 4.8 | 2.08 | 0.024 | 1.1 |
| Porous magnetic core 7 | (MnO)_{0.35}(MgO)_{0.12}(SrO)_{0.03}(Fe₂O₃)_{0.50} | 28.8 | 4.8 | 1.36 | 0.125 | 1.0 |
| Porous magnetic core 8 | (MnO)_{0.35}(MgO)_{0.12}(SrO)_{0.03}(Fe₂O₃)_{0.50} | 37.8 | 4.8 | 1.70 | 0.077 | 1.7 |
| Porous magnetic core 9 | (MnO)_{0.36}(MgO)_{0.05}(Fe₂O₃)_{0.59} | 36.2 | 4.8 | 1.72 | 0.075 | 0.7 |
| Porous magnetic core 10 | (MnO)_{0.35}(MgO)_{0.15}(SrO)_{0.01}(Fe₂O₃)_{0.50} | 35.5 | 4.8 | 1.65 | 0.082 | 1.1 |
| Magnetic core 11 | (CuO)_{0.25}(ZnO)_{0.25}(Fe₂O₃)_{0.50} | 55.2 | 5.0 | 2.61 | — | — |

In FIG. 2, the “cumulative pore volume” is the cumulative volume of pores of pore diameter ranging from 0.10 μm to 3.00 μm, while the “peak top pore diameter” is the diameter at which the log differential pore volume is maximum within the pore diameter ranging from 0.10 μm to 3.00 μm.

### Preparation Example

### Filler Resin Solution 1

3.0 mass % of 3-(2-aminoethyl)aminopropyl methyldimethoxysilane as a catalytic component was added to methyl silicone resin (Mw: 1.8×10⁴), to obtain a filler resin solution 1 with a solids concentration of 20%.

### Preparation Examples

### Filler Resin Solutions 2 to 6

The catalysts shown in Table 3 were added in the specified amounts as a percentage of the resin solids, and mixed in the same way as filler resin solution 1 to obtain filler resin solutions 2 to 6 with solids concentrations of 20%.

TABLE 3

| | Filling apparatus | Silicone resin | Catalyst | Added amt |
|---|---|---|---|---|
| Filler resin solution 1 | All-purpose agitation mixer | Methyl silicone resin | AS1 | 3.0 |
| | | (Mw: 1.8 × 10⁴) | | |
| Filler resin solution 2 | All-purpose agitation mixer | Methyl silicone resin | AS2 | 3.0 |
| | | (Mw: 1.8 × 10⁴) | | |
| Filler resin solution 3 | All-purpose agitation mixer | Methyl silicone resin | None | — |
| | | (Mw: 1.8 × 10⁴) | | |
| Filler resin solution 4 | All-purpose agitation mixer | Methyl silicone resin | Ti (3) | 1.5 |
| | | (Mw: 1.8 × 10⁴) | | |
| Filler resin solution 5 | All-purpose agitation mixer | Methyl silicone resin | Sn | 3.0 |
| | | (Mw: 1.8 × 10⁴) | | |
| Filler resin solution 6 | All-purpose agitation mixer | Methyl silicone resin | None | — |
| | | (Mw: 8.0 × 10³) | | |

Ti (3): Titanium tetraisopropoxide Ti(C₃H₇O)₄
Sn: Bis(acetoxydibutyltin)oxide
AS1: 3-(2-aminoethyl)aminopropyl methyldimethoxysilane
AS2: 3-aminopropyl triethoxysilane

### Preparation Example

### Coupling Treatment Solution 1

10 mass parts of 3-aminopropyl triethoxysilane were mixed with 90 mass parts of toluene to prepare coupling treatment solution 1.

### Preparation Example

### Coupling Treatment Solution 2

Coupling treatment solution 2 was prepared as in the preparation example of coupling treatment solution 1 using the coupling agent of Table 4.

TABLE 4

| | Coupling agent |
|---|---|
| Coupling treatment solution 1 | AS2 |
| Coupling treatment solution 2 | AS1 |

AS1: 3-(2-aminoethyl)aminopropyl methyldimethoxysilane
AS2: 3-aminopropyl triethoxysilane

### Preparation Example

### Coating Resin Solution 1

3-(2-aminoethyl)aminopropyl methyldimethoxysilane in the amount of 20 mass % of the resin solids was added as an aminosilane coupling agent to methyl silicone resin (Mw: 1.5×10⁴), titanium diisopropoxy bisacetyl acetonate was added as a catalyst in the amount of 1.5 mass % of the resin solids, and this was diluted appropriately with toluene to obtain coating resin solution 1 with a solids concentration of 20%.

### Preparation Examples

### Coating Resin Solutions 2 to 13

The catalysts and coupling agents shown in Table 5 were added and mixed in the prescribed amounts, and coating resin solutions 2 to 13 with solids concentrations of 20% were prepared in the same way as coating resin solution 1.

TABLE 5

| | | | | Added | | Added |
|---|---|---|---|---|---|---|
| | Coating apparatus | Silicone resin | Catalyst | amount | Coupling agent | amount |
| Coating resin solution 1 | Nauta Mixer | Methyl silicone resin | Ti (1) | 1.5 | AS1 | 20 |
| | | (Mw: 1.5 × 10⁴) | | | | |
| Coating resin solution 2 | Nauta Mixer | Methyl silicone resin | Ti (2) | 1.0 | AS1 | 20 |
| | | (Mw: 1.5 × 10⁴) | | | | |
| Coating resin solution 3 | Nauta Mixer | Methyl silicone resin | Ti (3) | 1.5 | AS1 | 20 |
| | | (Mw: 1.5 × 10⁴) | | | | |
| Coating resin solution 4 | Nauta Mixer | Methyl silicone resin | Ti (1) + Ti (2) | 0.5 + 0.5 | AS2 | 20 |
| | | (Mw: 1.5 × 10⁴) | | | | |
| Coating resin solution 5 | Nauta Mixer | Methyl silicone resin | Ti (3) | 1.5 | AS2 | 20 |
| | | (Mw: 1.5 × 10⁴) | | | | |
| Coating resin solution 6 | Nauta Mixer | Methyl silicone resin | Ti (2) | 1.5 | AS2 | 20 |
| | | (Mw: 1.5 × 10⁴) | | | | |
| Coating resin solution 7 | Nauta Mixer | Methyl silicone resin | Zr (1) | 1.5 | AS2 | 20 |
| | | (Mw: 1.5 × 10⁴) | | | | |
| Coating resin solution 8 | Nauta Mixer | Methyl silicone resin | Zr (1) | 1.5 | None added | — |
| | | (Mw: 1.5 × 10⁴) | | | | |
| Coating resin solution 9 | Nauta Mixer | Methyl silicone resin | Ti (3) | 1.5 | None added | — |
| | | (Mw: 1.5 × 10⁴) | | | | |
| Coating resin solution 10 | Nauta Mixer | Methyl silicone resin | Sn | 1.5 | None added | — |
| | | (Mw: 1.5 × 10⁴) | | | | |
| Coating resin solution 11 | Nauta Mixer | Methyl silicone resin | None added | — | None added | — |
| | | (Mw: 1.5 × 10⁴) | | | | |
| Coating resin solution 12 | Nauta Mixer | Methyl silicone resin | None added | — | None added | — |
| | | (Mw: 8.0 × 10³) | | | | |
| Coating resin solution 13 | Nauta Mixer | Methyl silicone resin | Ti (3) | 1.5 | None added | — |
| | | (Mw: 1.5 × 10⁴) | | | | |

Ti (1): Titanium diisopropylbis(acetylacetonate)(C₃H₇O)₂Ti(C₅H₇O₂)₂
Ti (2): Titanium diisopropoxybis(ethyl acetoacetate)(C₃H₇O)₂Ti(C₆H₉O₃)₂
Ti (3): Titanium tetraisopropoxide Ti(C₃H₇O)₄
Zr (1): Zirconium dibutoxybis(ethyl acetoacetate)(C₄H₉O)₂Zr(C₆H₉O₃)₂
Sn: Bis(acetoxydibutyltin)oxide
AS1: 3-(2-aminoethyl)aminopropyl methyldimethoxysilane
AS2: 3-aminopropyl triethoxysilane

### Manufacturing Example

### Magnetic Carrier 1

### Filling Step:

100 mass parts of porous magnetic core particles 1 were placed in a mixing stirrer (Dalton NDMV Versatile Mixer), and heated to 50° C. 11.0 mass parts of filler resin solution 1 were dripped into 100 mass parts of porous magnetic core particles 1 over 2 hours, and then agitated for a further 1 hour at 50° C. The temperature was then raised to 70° C. to completely remove the solvent. The resulting sample was transferred to a mixer having a spiral blade in a rotary mixing container (Sugiyama Heavy Industrial Co. UD-AT Drum Mixer), and heat treated for 2 hours at 220° C. in a nitrogen atmosphere. This was crushed, and the low-magnetized component was removed with a magnetic concentrator. This was then sorted with a 70 μm mesh to obtain filled core particles comprising porous magnetic core particles filled on the inside with resin.

Coupling Treatment Step:

100 mass parts of the resulting filled core particles were placed in a mixer (Hosokawa Micron VN Nauta Mixer), and maintained at 70° C. under reduced pressure with agitation at a screw rotation rate of 100 min⁻¹ and a rotation velocity of 3.5 min⁻¹. Coupling treatment solution 1 was added at 70° C. so as to obtain 0.5 mass parts of coupling agent per 100 mass parts of the filled core particles, and coating treatment was performed for 60 minutes to obtain filled core particles surface treated with a coupling agent.

Resin Coating Step:

100 mass parts of the filled core particles surface treated with a coupling agent were placed in a mixer (Hosokawa Micron VN Nauta Mixer), and agitated at a screw rotation rate of 100 min⁻¹ and a rotation velocity of 3.5 min⁻¹ as nitrogen was supplied at a flow rate of 0.1 m³/min and the temperature was adjusted to 70° C. under reduced pressure (75 mmHg). The coating resin solution 1 was added to a concentration of 1.0 mass part per 100 mass parts of filled core particles, and toluene removal and coating operations were performed for 60 minutes. The sample was then transferred to a mixer having a spiral blade in a rotary mixing container (Sugiyama Heavy Industrial Co. UD-AT Drum Mixer), and agitated by rotating the mixing container 10 times a minute while performing heat treatment for 4 hours at 220° C. udner a nitrogen atmosphere. A magnetic concentrator was used to separate out the low-magnetized component of the resulting magnetic carrier, which was then passed through a 70 μm sieve and classified with an air classifier to obtain a magnetic carrier 1 with a 50% particle diameter on a volume basis (D50) of 37.5 μm. The physical properties of the resulting magnetic carrier 1 are shown in Table 6.

### Manufacturing Examples

Magnetic Carriers 2 to 18

Magnetic carriers 2 to 18 were obtained as in the manufacturing example of magnetic carrier 1, except that the materials, equipment and manufacturing conditions were changed as shown in Table 7 in the manufacturing example of magnetic carrier 1. The physical properties of each magnetic carrier are shown in Table 6.

TABLE 6

| | Carrier properties | | | | |
|---|---|---|---|---|---|
| | | Apparent | | | |
| | | specific | | | |
| | D50 | density | σ1000 | σr | Hc |
| | [μm] | [g/cm³] | [Am²/kg] | [Am²/kg] | [A/m] |
| Carrier 1 | 37.5 | 1.78 | 50 | 0.9 | 876 |
| Carrier 2 | 37.7 | 1.80 | 50 | 0.9 | 876 |
| Carrier 3 | 39.4 | 1.80 | 51 | 0.9 | 876 |
| Carrier 4 | 37.2 | 1.80 | 50 | 0.9 | 876 |
| Carrier 5 | 38.8 | 1.78 | 50 | 0.9 | 876 |
| Carrier 6 | 35.2 | 1.84 | 51 | 0.8 | 876 |
| Carrier 7 | 36.2 | 1.64 | 48 | 1.0 | 955 |
| Carrier 8 | 38.8 | 2.16 | 53 | 0.8 | 876 |
| Carrier 9 | 34.7 | 1.62 | 48 | 1.0 | 955 |
| Carrier 10 | 50.4 | 2.18 | 53 | 0.8 | 876 |
| Carrier 11 | 29.8 | 1.52 | 47 | 1.1 | 1035 |
| Carrier 12 | 38.8 | 1.78 | 51 | 0.8 | 876 |
| Carrier 13 | 37.5 | 1.80 | 51 | 0.8 | 876 |
| Carrier 14 | 31.2 | 1.81 | 47 | 1.1 | 1035 |
| Carrier 15 | 29.9 | 1.83 | 48 | 1.1 | 1035 |
| Carrier 16 | 33.5 | 1.81 | 47 | 1.1 | 1035 |
| Carrier 17 | 38.5 | 1.73 | 50 | 0.9 | 876 |
| Carrier 18 | 56.1 | 1.81 | 53 | 0.4 | 478 |

TABLE 7

| | | Filling step | | | | | | Coupling treatment step | | | | | Resin coating step | | | | | |
|---|---|---|---|---|---|---|---|---|---|---|---|---|---|---|---|---|---|---|
| | | | | | | Heat | | | | | Heat | | | | | | Heat | |
| | | | | | | treat- | | | | | treat- | | | | | | treat- | |
| | | | | | | ment | | | | | ment | | | | | | ment | |
| | | | Filling | Filling | Filled | temper- | | Coupling | Coupling | Treatment | temper- | | | Coating | Coating | Coated | temper- | |
| | Core lot | | apparatus | conditions | amount | ature | Time | agent | agent | amount | ature | Time | | apparatus | conditions | amount | ature | Time |
| Carrier 1 | Porous | Filler resin | All- | Reduced | 11.0 | 220° C. | 2 hours | Coupling | AS2 | 0.5 | 160° C. | 2 hours | Coating | Nauta | Reduced | 1.0 | 220° C. | 4 hours |
| | magnetic | solution 1 | purpose | pressure | | | | treatment | | | | | resin | Mixer | pressure | | | |
| | core 1 | | agitating | (200 mmHg) | | | | solution 1 | | | | | solution 1 | | (70 mmHg) | | | |
| | | | mixer | 50→70° C. | | | | | | | | | | | 70° C. | | | |
| Carrier 2 | ↑ | ↑ | ↑ | ↑ | 11.0 | ↑ | ↑ | ↑ | ↑ | ↑ | ↑ | ↑ | Coating | ↑ | ↑ | 1.0 | ↑ | ↑ |
| | | | | | | | | | | | | | resin | | | | | |
| | | | | | | | | | | | | | solution 2 | | | | | |
| Carrier 3 | ↑ | ↑ | ↑ | ↑ | 11.0 | ↑ | ↑ | ↑ | ↑ | ↑ | ↑ | ↑ | Coating | ↑ | ↑ | 1.0 | ↑ | ↑ |
| | | | | | | | | | | | | | resin | | | | | |
| | | | | | | | | | | | | | solution 3 | | | | | |
| Carrier 4 | ↑ | ↑ | ↑ | ↑ | 11.0 | ↑ | ↑ | Coupling | AS1 | 0.5 | ↑ | ↑ | Coating | ↑ | ↑ | 1.0 | ↑ | ↑ |
| | | | | | | | | treatment | | | | | resin | | | | | |
| | | | | | | | | solution 2 | | | | | solution 4 | | | | | |
| Carrier 5 | ↑ | Filler resin | ↑ | ↑ | 11.0 | ↑ | ↑ | — | None | — | — | — | Coating | ↑ | ↑ | 1.0 | ↑ | ↑ |
| | | solution 2 | | | | | | | | | | | resin | | | | | |
| | | | | | | | | | | | | | solution 5 | | | | | |
| Carrier 6 | Porous | ↑ | ↑ | ↑ | 9.5 | ↑ | ↑ | — | None | — | — | — | Coating | ↑ | ↑ | 1.0 | ↑ | ↑ |
| | magnetic | | | | | | | | | | | | resin | | | | | |
| | core 2 | | | | | | | | | | | | solution 6 | | | | | |
| Carrier 7 | Porous | ↑ | ↑ | ↑ | 14.0 | ↑ | ↑ | — | None | — | — | — | ↑ | ↑ | ↑ | 1.0 | ↑ | ↑ |
| | magnetic | | | | | | | | | | | | | | | | | |
| | core 3 | | | | | | | | | | | | | | | | | |
| Carrier 8 | Porous | Filler resin | ↑ | ↑ | 5.0 | ↑ | ↑ | — | None | — | — | — | ↑ | ↑ | ↑ | 1.0 | ↑ | ↑ |
| | magnetic | solution 3 | | | | | | | | | | | | | | | | |
| | core 4 | | | | | | | | | | | | | | | | | |
| Carrier 9 | Porous | ↑ | ↑ | ↑ | 14.0 | ↑ | ↑ | — | None | — | — | — | Coating | ↑ | ↑ | 1.0 | ↑ | ↑ |
| | magnetic | | | | | | | | | | | | resin | | | | | |
| | core 5 | | | | | | | | | | | | solution 7 | | | | | |
| Carrier 10 | Porous | ↑ | ↑ | ↑ | 4.0 | ↑ | ↑ | — | None | — | — | — | ↑ | ↑ | ↑ | 0.8 | ↑ | ↑ |
| | magnetic | | | | | | | | | | | | | | | | | |
| | core 6 | | | | | | | | | | | | | | | | | |
| Carrier 11 | Porous | ↑ | ↑ | ↑ | 16.0 | ↑ | ↑ | — | None | — | — | — | ↑ | ↑ | ↑ | 1.0 | ↑ | ↑ |
| | magnetic | | | | | | | | | | | | | | | | | |
| | core 7 | | | | | | | | | | | | | | | | | |
| Carrier 12 | Porous | Filler resin | ↑ | ↑ | 10.5 | ↑ | ↑ | — | None | — | — | — | Coating | ↑ | ↑ | 0.3 | ↑ | ↑ |
| | magnetic | solution 1 | | | | | | | | | | | resin | | | | | |
| | core 8 | | | | | | | | | | | | solution 8 | | | | | |
| Carrier 13 | Porous | ↑ | ↑ | ↑ | 10.0 | ↑ | ↑ | — | None | — | — | — | ↑ | ↑ | ↑ | 0.3 | ↑ | ↑ |
| | magnetic | | | | | | | | | | | | | | | | | |
| | core 9 | | | | | | | | | | | | | | | | | |
| Carrier 14 | Porous | Filler resin | ↑ | ↑ | 10.0 | ↑ | ↑ | — | None | — | — | — | Coating | ↑ | ↑ | 0.3 | ↑ | ↑ |
| | magnetic | solution 4 | | | | | | | | | | | resin | | | | | |
| | core 7 | | | | | | | | | | | | solution 9 | | | | | |
| Carrier 15 | ↑ | Filler resin | ↑ | ↑ | 10.0 | ↑ | ↑ | — | None | — | — | — | Coating | ↑ | ↑ | 0.3 | ↑ | ↑ |
| | | solution 3 | | | | | | | | | | | resin | | | | | |
| | | | | | | | | | | | | | solution 10 | | | | | |
| Carrier 16 | ↑ | Filler resin | ↑ | ↑ | 10.0 | ↑ | ↑ | — | None | — | — | — | Coating | ↑ | ↑ | 2.0 | ↑ | ↑ |
| | | solution 5 | | | | | | | | | | | resin | | | | | |
| | | | | | | | | | | | | | solution 11 | | | | | |
| Carrier 17 | Porous | Filler resin | ↑ | ↑ | 11.0 | 250° C. | 2 hours | — | None | — | — | — | Coating | ↑ | Atmospheric | 0.5 | 250° C. | 2 hours |
| | magnetic | solution 6 | | | | | | | | | | | resin | | pressure | | | |
| | core 10 | | | | | | | | | | | | solution 12 | | 60° C. | | | |
| Carrier 18 | Magnetic | — | — | — | — | — | — | — | None | — | — | — | Coating | ↑ | Reduced | 1.5 | ↑ | ↑ |
| | core 11 | | | | | | | | | | | | resin | | pressure | | | |
| | | | | | | | | | | | | | solution 13 | | (70 mmHg) | | | |
| | | | | | | | | | | | | | | | 70° C. | | | |

### Manufacturing Example

### Binder Resin A

The following materials were weighed in a reaction tank equipped with a cooling tube, a shaker and a nitrogen introduction tube.

| | |
|---|---|
| Terephthalic acid | 288 mass parts |
| Polyoxypropylene(2.2)-2,2-bis(4-hydroxyphenyl)propane | 880 mass parts |
| Titanium dihydroxybis(triethanolaminate) | 1 mass part |

This was then heated to 210° C. under a nitrogen atmosphere, and reacted for 9 hours as the resulting water was removed. 61 mass parts of anhydrous trimellitic acid were added, heated at 180° C., and reacted for 3 hours to synthesize binder resin A.

As determined by GPC, binder resin A had a weight-average molecular weight (Mw) of 65,000, a number-average molecular weight (Mn) of 6,800, a peak molecular weight (Mp) of 11,500, and a glass transition temperature (Tg) of 63°.

<Manufacture of Cyan Master Batch>

| | |
|---|---|
| Binder resin A | 60 mass parts |
| Cyan pigment (C.I. pigment blue 15:3) | 40 mass parts |

These materials were melted and kneaded in a kneader-mixer to prepare a cyan master batch.

### Manufacturing Example

### Toner A

| | |
|---|---|
| Binder resin A | 92.5 mass parts |
| purified paraffin wax (maximum endothermic peak | 5.0 mass parts |
| temperature = 70° C., Mw = 450, Mn = 320) | |
| Cyan master batch from above (colorant 40 mass %) | 12.5 mass parts |
| 3,5-di-tertiary butylsalicilic acid aluminum compound | 0.9 mass parts |
| (negative charge control agent) | |

These ingredients were mixed in a Henschel Mixer (FM-75, Mitsui Miike), and kneaded in a twin-screw kneader (PCM-30, Ikegai Iron Works) that is set to a temperature of 160° C. The kneaded product was cooled, and coarsely pulverized in a hammer mill to 1 mm or less to obtain a coarse product. The coarse product was finely pulverized in a mechanical pulverizer (T-250, Turbo Industries), and the finely pulverized product was subjected to sphering treatment. This was then classified in an air classifier using the Coanda effect (Elbow Jet Labo EJ-L3, Nittetsu Mining) to simultaneously separate out the fine powder and coarse powder and obtain cyan toner particle. 1.0 mass part of STT-30A (Titan Kogyo, Ltd.) and 1.0 mass part of Aerosil R972 (Nippon Aerosil Co., Ltd) were added per 100 mass parts of the resulting cyan toner particles, and mixed in a Henschel Mixer (FM-75, Mitsui Miike) to obtain Toner A. The resulting Toner A had a circle-equivalent diameter of at least 1.985 μm but less than 39.69 μm, an average circularity of 0.975, and a weight-average particle diameter (D4) of 6.7 μm. The average circularity and weight-average particle diameter (D4) are shown in Table 8.

### Manufacturing Examples

### Toners B, C

Toners B and C were obtained as in the manufacturing example of Toner A except that the pulverization step and classification/surface modification step were changed as shown in Table 8 in the manufacturing example of Toner A. Table 8 shows the average circularity and weight-average particle diameters (D4) of the toners.

TABLE 8

| | | | | Weight-average | |
|---|---|---|---|---|---|
| | | | | particle | |
| | | | | diameter (D4) | Average |
| | Pulverization step | Post-treatment step 1 | Post-treatment step 2 | μm | circularity |
| Toner A | Mechanical pulverization | Heat sphering treatment | Elbow jet classification | 6.7 | 0.975 |
| | | (see FIG. 1) | | | |
| Toner B | Mechanical pulverization | Simultaneous | — | 6.2 | 0.945 |
| | | sphering/classification | | | |
| | | (faculty) | | | |
| Toner C | Mechanical pulverization/ | Elbow jet classification | — | 5.4 | 0.932 |
| | mechanical pulverization | | | | |

### Example 1

9.20 g of the magnetic carrier 1 was weighed into a 50 ml hard polyethylene wide-neck bottle with screw thread. 0.80 g of toner A was then weighed, and the magnetic carrier and toner were superimposed. For convenience of measurement, two samples were prepared under normal humidity, low temperature conditions (23° C., 5% RH), one under normal temperature, normal humidity conditions (23° C., 50% RH), and one under high-temperature, high-humidity conditions (30° C., 80% RH), and left standing with the caps open for 24 hours or more to adjust the humidity.

After humidity adjustment, the wide-necked bottles were capped, and rotated 15 times at a rate of 1 rotation per second in a roll mill. They were then mixed in an arm-swing shaking mixer at a shaking angle of 30 degrees. Two types of samples that had been humidity-adjusted under normal-humidity, low-temperature conditions (23° C., 5% RH) were prepared, one being obtained after shaking for 10 seconds and the other being obtained after shaking for 300 seconds. Shaking was carried out 150 times per minute. Further, the samples that had been humidity-adjusted under high-temperature, high-humidity conditions (30° C., 80% RH) were each shaken for 300 seconds. A Separ-soft STC-1-C1 suction separation charge quantity-measuring device (Sankyo Pio-Tech) was used as the equipment for measuring the triboelectric charge quantity. A 20 μm metal mesh was installed at the bottom of a sample holder (faraday cage), 0.10 g of the developer prepared as described above was placed on the mesh, and the holder is capped. The mass of the sample holder as a whole at that time was weighed and given as W1 (g). Next, the sample holder was installed in the main body of the apparatus, and the suction pressure was set to 2 kPa by adjusting an air quantity control valve. Under these conditions, the toner was removed by suction for 1 minute. The current at that time was given as Q(μC). In addition, the mass of the sample holder as a whole after suction was weighed and given as W2 (g). Since Q determined at that time corresponds to the measured value for the charge of the carrier, the triboelectric charge quantity of the toner is opposite in polarity to Q. The absolute value for the triboelectric charge quantity (mC/kg) of the developer is calculated as: triboelectric charge quantity (mC/kg)=|Q/(W1−W2)|. These measurements were performed on the samples prepared in each environment. Table 9 shows the measurement results for charge quantity.

Using a reconstructed commercial Canon imagePRESS C1 digital print system as the image-forming apparatus, the aforementioned developer was loaded into the cyan developing device, and a 50,000-sheet output test was performed using an image with an image ratio of 40% in a high-temperature, high-humidity environment (30° C., 80% RH). CS-814 laser printer paper (A4, 81.4 g/m², Canon Marketing Japan) was used as the transfer medium.

The image-forming apparatus was reconstructed by removing the mechanism that discharges excess magnetic carrier from inside the developing device. On the developer carrying member, an electrical field was formed in the developing zone by applying DC voltage V_{DC} and AC voltage with a frequency of 2.0 kHz, with the Vpp varied from 0.7 kV to 1.8 kV in 0.1 kV increments. The Vpp was determined so as to achieve toner laid-on level of 0.45 mg/cm².

Following the 50,000-sheet output test, the developer was sampled from the developing device. The humidity of the collected developer was adjusted overnight in a high-temperature, high-humidity environment (30° C., 80% RH), and then adjusted for 24 hours or more in a normal-temperature, normal-humidity environment (23° C., 50% RH). Magnetic carrier 1 was then separated from the collected developer with a field separation charge quantity measurement device (Etwas Higashi Ohsaka Kenkyujo). The specific operations were as follows. The collected developer was supported on the inner sleeve of the aforementioned apparatus, and subjected to field separation, causing the toner to escape to the outer sleeve. The outer sleeve was replaced, and the same separation operation was repeated 5 times until all of the toner had escaped. Magnetic carrier 1 remaining on the inner sleeve (post-endurance magnetic carrier 1) was then collected. The separation conditions are shown in detail below. As in the case of the previous charge quantity measurement, the charge quantity was measured after 5 minutes of shaking following 24 hours or more of humidity adjustment in a normal-temperature, normal-humidity environment (23° C., 50% RH) using a combination of the post-endurance magnetic carrier 1 and toner A. The charge quantity measurement results are shown in Table 9.

<Separation Conditions>

Measurement environment: 23° C., 50% RH

Sample amount: about 1.5 g

Applied voltage: −3.0 kV

Magnet roller rotation within inner sleeve: 2000 rpm

Application time: 60 s

Distance between outer and inner sleeves: 5 mm

1) Charge Rising Performance

The charge rising performance was evaluated based on the charge quantity in a normal-temperature, low-humidity environment (23° C., 5% RH). The charge rising performance of the developer is evaluated based on the degree to which the charge quantity reached after 300 seconds of mixing the toner and magnetic carrier is reached after 10 seconds of mixing them (charge rising rate). The charge quantity after 10 seconds of mixing is given as Q/M(10) and the charge quantity after 300 seconds as Q/M(300), and the Q/M(10) divided by the Q/M(300) is given as a percentage as the charge rising rate. The evaluation results are shown in Table 9.

(Evaluation Standard)

A: Charge rising rate 90% or more.
B: Charge rising rate at least 80% but less than 90%.
C: Charge rising rate at least 75% but less than 80%.
D: Charge rising rate less than 75%.

2) Environmental Difference

The difference between the charge quantity after 300 seconds of mixing in a normal-humidity, low-temperature environment (23° C., 5% RH) and the charge quantity after 300 seconds of mixing in a high-temperature, high-humidity environment (30° C., 80% RH) was evaluated as the environmental difference. The evaluations results are shown in Table 9.

(Evaluation Standard)

A: Difference in charge quantity less than 10 mC/kg.
B: Difference in charge quantity at least 10 mC/kg but less than 15 mC/kg.
C: Difference in charge quantity at least 15 mC/kg but less than 20 mC/kg.
D: Difference in charge quantity 20 mC/kg or more.

3) Decrease in Charge-Providing Function after 50,000-Sheet Image Output Test

The charge quantity of toner A and carrier 1 humidity-adjusted in a normal-temperature, low-humidity environment (23° C., 5% RH) was given as Q/M(0K), while the charge quantity of post-endurance toner A and carrier 1 humidity-adjusted in a normal-temperature, low-humidity environment (23° C., 5% RH) was given as Q/M(50K). The decrease in charge-providing function was then determined according to the following formula. The evaluation results are shown in Table 9.

Decrease in charge-providing function={(Q/M(0K)−Q/M(50K))/Q/M(0K)}×100

(Evaluation Standard)

A: Less than 10% decrease in charge-providing function.
B: At least 10% but less than 20% decrease in charge-providing function.
C: At least 20% but less than 30% decrease in charge-providing function.
D: 30% or greater decrease in charge-providing function.

TABLE 9

| | Developer charge characteristics | | | | | | | | | | |
|---|---|---|---|---|---|---|---|---|---|---|---|
| | | | | | | | | | Decrease in | | |
| | | | | | | | | | charge-providing | | |
| | Charge quantity | | | | | | | | function after | | |
| | | | Normal | High | | | | | 50,000-sheet | | |
| | | | temper- | temper- | | | | | 40% duty | | |
| | Normal | Normal | ature, | ature, | | | | | 50K | | |
| | temperature, | temperature, | normal | high | | | | | Separated | | |
| | low | low | humidity, | humidity, | Charge rising | | Environmental | | carrier | | |
| | humidity, | humidity, | 300 | 300 | performance | | difference | | NN charge | | |
| | 10 seconds | 300 seconds | seconds | seconds | Rising | | ΔQ/M | | quantity | Decrease | |
| | [mC/Kg] | [mC/Kg] | [mC/Kg] | [mC/Kg] | rate (%) | Evaluation | (NL − HH) | Evaluation | [mC/Kg] | (%) | Evaluation |
| Example 1 | 55 | 60 | 56 | 55 | 92 | A | 5 | A | 54 | 3.6 | A |
| Example 2 | 54 | 60 | 56 | 54 | 90 | A | 6 | A | 54 | 3.6 | A |
| Example 3 | 55 | 61 | 56 | 52 | 90 | A | 9 | A | 51 | 8.9 | A |
| Example 4 | 53 | 59 | 51 | 52 | 90 | A | 7 | A | 48 | 5.9 | A |
| Example 5 | 53 | 61 | 56 | 54 | 87 | B | 7 | A | 52 | 7.1 | A |
| Example 6 | 50 | 55 | 46 | 44 | 91 | A | 11 | B | 41 | 10.9 | B |
| Example 7 | 49 | 56 | 46 | 43 | 88 | B | 13 | B | 40 | 13.0 | B |
| Example 8 | 51 | 56 | 47 | 45 | 91 | A | 11 | B | 41 | 12.8 | B |
| Example 9 | 46 | 55 | 45 | 42 | 84 | B | 13 | B | 40 | 11.1 | B |
| Example 10 | 38 | 49 | 39 | 34 | 78 | C | 15 | C | 30 | 23.1 | C |
| Example 11 | 39 | 50 | 41 | 34 | 78 | C | 16 | C | 30 | 26.8 | C |
| Example 12 | 43 | 52 | 40 | 41 | 83 | B | 11 | B | 31 | 22.5 | C |
| Example 13 | 34 | 42 | 33 | 25 | 81 | B | 17 | C | 24 | 27.3 | C |
| Example 14 | 37 | 44 | 33 | 26 | 84 | B | 18 | C | 25 | 24.2 | C |
| Comparative | 30 | 46 | 35 | 27 | 65 | D | 19 | C | 25 | 28.6 | C |
| Example 1 | | | | | | | | | | | |
| Comparative | 37 | 45 | 28 | 21 | 82 | B | 24 | D | 22 | 21.4 | C |
| Example 2 | | | | | | | | | | | |
| Comparative | 30 | 35 | 26 | 20 | 86 | B | 15 | C | 19 | 26.9 | C |
| Example 3 | | | | | | | | | | | |
| Comparative | 28 | 35 | 20 | 14 | 80 | B | 21 | D | 13 | 35.0 | D |
| Example 4 | | | | | | | | | | | |
| Comparative | 25 | 34 | 22 | 14 | 74 | D | 20 | D | 14 | 36.4 | D |
| Example 5 | | | | | | | | | | | |
| Comparative | 28 | 38 | 22 | 15 | 74 | D | 23 | D | 10 | 54.5 | D |
| Example 6 | | | | | | | | | | | |

4) Fogging

### Initial Fogging

Before the 50,000-sheet image output test, the Vback was set to 150 V by adjusting the DC voltage V_{DC}, and 1 solid white image was printed.

The average reflectance Dr (%) of the paper before image formation and reflectance Ds (%) of the solid white image were measured with a reflectometer (Tokyo Denshoku K.K. Reflectometer Model TC-6DS). Fogging (%) was calculated as Dr (%)−Ds (%), and evaluated according to the following standard. The evaluation results are shown in Table 10.

(Evaluation Standard)

A: Less than 0.5% fogging.
B: At least 0.5% but less than 1.0% fogging.
C: At least 1.0% but less than 2.0% fogging.
D: 2.0% or more fogging.

Fogging During Replenishment

After the leak test described below, the toner concentration of the two-component developer was adjusted to 8%, and 1000 prints of an image with an image ratio of 50% were output continuously. The Vback was then set to 150 V by adjusting the DC voltage V_{DC}, 1 solid white image was printed, and fogging was evaluated as before. The evaluation results are shown in Table 10.

5) Leak Test (White Spots)

Toner replenishment was stopped after completion of the aforementioned test of fogging during replenishment, toner was consumed, and the two-component developer was used with a toner concentration of 4%.

5 solid (FFH) images were output continuously on ordinary A4 paper, and the exposed white areas (white spots) 1 mm or more in diameter on the image were counted. White spots were counted on 5 solid images, and the evaluation was based on the total number of spots. The developer before the (initial) image output test was evaluated in the same way with a toner concentration of 4% of the two-component developer. The evaluation results are shown in Table 10.

(Evaluation Standard)

A: 0 white spots.
B: 1 to less than 5 white spots.
C: 5 to less than 20 white spots.
D: 20 to less than 100 white spots.

6) After the developing performance 50,000-sheet image output test, the two-component developer was adjusted to a toner concentration of 8%. A single-color solid image was formed with a toner laid-on level of 0.45 mg/cm² by adjusting the Vpp. The Vpp required to obtain a toner laid-on level of 0.45 mg/cm² was then evaluated according to the following standard. The evaluation results are shown in Table 10.

(Evaluation Standard)

A: Toner laid-on level is 0.45 mg/cm² when Vpp is 1.3 kV or less.
B: Toner laid-on level is 0.45 mg/cm² when Vpp is greater than 1.3 kV but no more than 1.5 kV.
C: Toner laid-on level is 0.45 mg/cm² when Vpp is greater than 1.5 kV but no more than 1.8 kV.
D: Toner laid-on level is less than 0.45 mg/cm² when Vpp is greater than 1.8 kV.

7) Accumulation of External Additive

The magnetic carrier 1 separated and collected after the 50,000-sheet image output test under high-temperature, high-humidity conditions (30° C., 80% RH) was measured by x-ray fluoroscopy (XRF) to determine the Ti intensity (Ti1). The Ti intensity (Ti2) of a magnetic carrier 1 that had not undergone an endurance test was also measured. The difference in the amount of titanium oxide from the external additive that moved from the toner to accumulate on the surfaces of the magnetic carrier particles was evaluated based on the difference in fluorescent x-ray intensity (Ti1−Ti2).

(Evaluation Standard)

A: Almost no accumulation of titanium oxide from external additive (Ti1−Ti2 is less than 0.050 kcps).
B: Slight accumulation of titanium oxide from external additive (Ti1−Ti2 is at least 0.050 kcps but less than 0.100 kcps).
C: Accumulation of titanium oxide from external additive exists, but is not a practical problem (Ti1−Ti2 is at least 0.100 kcps but less than 0.200 kcps).
D: Significant accumulation of titanium oxide from external additive, sufficient to affect charge-providing function (Ti1−Ti2 is greater than 0.200 kcps).

TABLE 10

| | Durability | | | | | | | | | | | |
|---|---|---|---|---|---|---|---|---|---|---|---|---|
| | | | | | | | | | Developing | | | |
| | Fogging | | | | | | | | performance | | Accumulation of | |
| | | | After 50,000 | | White spots | | | | | After | external additive | |
| | | | sheets prints | | | | After 50,000 | | | 50,000 | Fluorescence x-ray | |
| | Initial | | 40% duty 50K | | Initial | | sheets prints | | | sheets | intensity change | |
| | Initial | | Foging during | | number | | number of | | | prints | ΔXRF | |
| | fogging | | replenishment | | of white | | white | | Initial | after | intensity | |
| | [%] | Evaluation | [%] | Evaluation | spots | Evaluation | spots | Evaluation | Initial | duration | [kcps] | Evaluation |
| Example 1 | 0.1 | A | 0.2 | A | 0 | A | 0 | A | A | A | 0.028 | A |
| Example 2 | 0.1 | A | 0.3 | A | 0 | A | 0 | A | A | A | 0.035 | A |
| Example 3 | 0.2 | A | 0.3 | A | 1 | B | 3 | B | A | A | 0.048 | A |
| Example 4 | 0.3 | A | 0.3 | A | 0 | A | 1 | B | A | A | 0.032 | A |
| Example 5 | 0.1 | A | 0.4 | A | 0 | A | 1 | B | A | B | 0.040 | A |
| Example 6 | 0.5 | B | 1.1 | C | 0 | A | 4 | B | A | B | 0.078 | B |
| Example 7 | 0.6 | B | 1.0 | C | 3 | B | 5 | C | A | B | 0.064 | B |
| Example 8 | 0.5 | B | 0.9 | B | 1 | B | 4 | B | A | B | 0.055 | B |
| Example 9 | 0.7 | B | 1.2 | C | 1 | B | 6 | C | B | C | 0.065 | B |
| Example 10 | 0.9 | B | 1.6 | C | 4 | B | 7 | C | B | C | 0.142 | C |
| Example 11 | 0.9 | B | 1.7 | C | 5 | C | 9 | C | B | C | 0.166 | C |
| Example 12 | 0.7 | B | 1.4 | C | 4 | B | 9 | C | B | C | 0.150 | C |
| Example 13 | 1.2 | C | 1.8 | C | 6 | C | 12 | C | B | C | 0.177 | C |
| Example 14 | 1.4 | C | 1.9 | C | 9 | C | 18 | C | B | C | 0.180 | C |
| Comparative | 1.9 | C | 2.2 | D | 8 | C | 18 | C | B | D | 0.192 | C |
| Example 1 | | | | | | | | | | | | |
| Comparative | 2.5 | D | 3.5 | D | 5 | C | 30 | D | D | D | 0.144 | C |
| Example 2 | | | | | | | | | | | | |
| Comparative | 2.5 | D | 3.4 | D | 20 | D | 35 | D | D | D | 0.390 | D |
| Example 3 | | | | | | | | | | | | |
| Comparative | 3.4 | D | 4.7 | D | 22 | D | 35 | D | C | D | 0.434 | D |
| Example 4 | | | | | | | | | | | | |
| Comparative | 3.5 | D | 4.5 | D | 22 | D | 45 | D | C | D | 0.444 | D |
| Example 5 | | | | | | | | | | | | |
| Comparative | 3.7 | D | 5.8 | D | 15 | C | 25 | D | D | D | 0.225 | D |
| Example 6 | | | | | | | | | | | | |

<Examples 2 to 14, Comparative Examples 1 to 6>

Magnetic carrier and toner were combined as shown in Table 11, and evaluated in the same way as in Example 1. The evaluation results for each of the two-component developers are shown in Tables 9 and 10.

TABLE 11

| | | | | Average |
|---|---|---|---|---|
| | Magnetic carrier | Core | Toner | circularity |
| Example 1 | Carrier 1 | Porous magnetic | Toner A | 0.975 |
| | | core 1 | | |
| Example 2 | Carrier 2 | ↑ | ↑ | ↑ |
| Example 3 | Carrier 3 | ↑ | ↑ | ↑ |
| Example 4 | Carrier 4 | ↑ | ↑ | ↑ |
| Example 5 | ↑ | ↑ | Toner B | 0.945 |
| Example 6 | Carrier 5 | ↑ | Toner A | 0.975 |
| Example 7 | Carrier 6 | Porous magnetic | ↑ | ↑ |
| | | core 2 | | |
| Example 8 | Carrier 7 | Porous magnetic | ↑ | ↑ |
| | | core 3 | | |
| Example 9 | Carrier 8 | Porous magnetic | ↑ | ↑ |
| | | core 4 | | |
| Example 10 | Carrier 9 | Porous magnetic | ↑ | ↑ |
| | | core 5 | | |
| Example 11 | Carrier 10 | Porous magnetic | ↑ | ↑ |
| | | core 6 | | |
| Example 12 | Carrier 11 | Porous magnetic | ↑ | ↑ |
| | | core 7 | | |
| Example 13 | Carrier 12 | Porous magnetic | ↑ | ↑ |
| | | core 8 | | |
| Example 14 | Carrier 13 | Porous magnetic | ↑ | ↑ |
| | | core 9 | | |
| Comparative | ↑ | ↑ | Toner C | 0.932 |
| Example 1 | | | | |
| Comparative | Carrier 14 | Porous magnetic | Toner A | 0.975 |
| Example 2 | | core 7 | | |
| Comparative | Carrier 15 | ↑ | ↑ | ↑ |
| Example 3 | | | | |
| Comparative | Carrier 16 | ↑ | ↑ | ↑ |
| Example 4 | | | | |
| Comparative | Carrier 17 | Porous magnetic | ↑ | ↑ |
| Example 5 | | core 10 | | |
| Comparative | Carrier 18 | Magnetic core 11 | ↑ | ↑ |
| Example 6 | | | | |

### REFERENCE SIGNS LIST

1 Raw material toner
2 Autofeeder
3 Supply nozzle
4 Surface modification apparatus interior
5 Hot air introduction port
6 Cool air introduction port
7 Surface-modified toner particles
8 Cyclone
9 Blower

1. A two-component developer containing a magnetic carrier and a toner,
wherein the magnetic carrier comprises magnetic carrier particles each of which comprises a filled core particle and a silicone resin B, the surface of the filled core particle being coated with the silicone resin B,
wherein the filled core particle comprises a porous magnetic core particle and a silicone resin A, pores of the porous magnetic core particle being filled with a silicone resin A,
wherein the silicone resin A is a silicone resin cured in the presence of a non-metal catalyst or without a catalyst, while the silicone resin B is a silicone resin cured in the presence of a metal catalyst having titanium or zirconium,
and wherein the toner contains a binder resin, a release agent and a colorant, and has an average circularity of 0.940 or more.

2. The two-component developer according to claim 1, wherein the metal catalyst has one or more titanium catalysts selected from the group consisting of a titanium alkoxide catalyst and a titanium chelate catalyst.

3. The two-component developer according to claim 1, wherein in a pore diameter distribution of the porous magnetic core particles as measured by a mercury intrusion method,
the pore diameter at which a log differential pore volume is maximum within a range of pore diameter ranging from 0.10 μm to 3.00 μm, is in a range from 0.70 μm to 1.30 μm, and
a cumulative pore volume of pores within a range of pore diameter ranging from 0.10 μm to 3.00 μm, is in a range from 0.03 ml/g to 0.12 ml/g.
